(19) United States
(12) Patent Application Publication
(10) Pub. No.: US 2013/0108858 A1
(43) Pub. Date: May 2, 2013

(54) Methods for Making an Article Coated with a Photochromic Film and Use Thereof in Ophthalmological Optics

(71) Applicants: John Biteau, St Petersburg, FL (US); Jean-Pierre Boilot, Meudon La Foret (FR); Thierry Gacoin, Bures Sur Yvette (FR); Muriel Matheron, Charenton-Le-Pont (FR); Lorraine Raboin, Charenton-Le-Pont (FR)

(72) Inventors: John Biteau, St Petersburg, FL (US); Jean-Pierre Boilot, Meudon La Foret (FR); Thierry Gacoin, Bures Sur Yvette (FR); Muriel Matheron, Charenton-Le-Pont (FR); Lorraine Raboin, Charenton-Le-Pont (FR)

(73) Assignee: Essilor International (Compagnie Generate d Optique, Charenton Le Pont (FR)

(21) Appl. No.: 12/278,130

(22) PCT Filed: Jan. 31, 2007
(86) PCT No.: PCT/FR2007/050718

§ 371 Date: Aug. 1, 2008

(30) Foreign Application Priority Data
Feb. 2, 2006 (FR) 0650380

(51) Int. Cl. B32B 3/26; B05D 3/06; B05D 3/02; B05D 3/10

(52) U.S. Cl. 428/304.4; 427/384; 427/337; 427/540; 427/553; 427/532

(57) ABSTRACT

The present invention relates to a method for making a substrate coated with a mesoporous photochromic film, comprising:
a) preparing a precursor sol of a mesoporous film comprising an inorganic precursor agent, at least one organic solvent, water, at least one pore-forming agent and one hydrophobic precursor agent bearing at least one hydrophobic group;
b) depositing a film of the precursor sol onto a main surface of a substrate;
c) removing the pore-forming agent from the film resulting from the previous step at a temperature ≦150° C.;
d) impregnating the mesoporous film resulting from step c) with a solution comprising at least one photochromic agent.

In an alternative embodiment, the photochromic agent is directly introduced into the precursor sol. In an alternative embodiment of the previous alternative embodiment, the precursor sol does not comprise any hydrophobic precursor agent but the photochromic film is made hydrophobic by a treatment subsequent to its preparation.

The present invention generally relates to methods for making an article, especially made of plastic material, coated with an optionally mesostructured, photochromic sol-gel film, and to the thus resulting coated articles. These articles are advantageously used in the optical field.

More particularly, the present invention relates to a method for making a transparent article, preferably made of plastic material, such as an optical or an ophthalmic lens or lens blank, coated with a photochromic film.

In the present application, mesoporous materials are defined as being solids comprising in their structure pores with a size ranging from 2 to 50 nm, which are called mesopores. Such pores are half way in size between macropores (size >50 nm) and micropores from materials of the zeolite type (size <2 nm). These definitions do comply with those given in the IUPAC Compendium of Chemistry Terminology, 2^{nd} Ed., A. D. McNaught and A. Wilkinson, RSC, Cambridge, UK, 1997.

The mesopores may be void, that is to say filled with air, or only partially void. The mesopores are generally randomly distributed within the structure, with a large size distribution.

Mesoporous materials and their preparation have been extensively described in the literature, especially in Science 1983, 220, 365371 or in The Journal of Chemical Society, Faraday Transactions 1985, 81, 545-548.

In the present application, structured materials are defined as being materials having an organized structure, more specifically characterized by the existence of at least one diffraction peak in an X-rays or neutrons diffraction pattern. The diffraction peaks that are observed in such a diagram may be associated with a repetition of a distance which is a characteristic of the material, called spatial repetition period of the structured system.

In the present application, a mesostructured material is defined as being a structured material having a spatial repetition period ranging from 2 to 50 nm. Structured mesoporous (or ordered mesoporous) materials belong to a particular class of mesostructured materials, which are mesoporous materials having an organized spatial arrangement of the mesopores which are present within their structure, therefore resulting in a spatial repetition period.

The usual method for preparing optionally structured, mesoporous films consists in preparing a poorly polymerized sol from an inorganic material such as silica, based on a precursor such as a tetraalkoxysilane, in particular tetraethoxysilane (TEOS), such a sol also comprising water, a generally polar, organic solvent such as ethanol, and a pore-forming agent, most often in an acidic medium.

When the pore-forming agent is an amphiphilic agent, for example a surfactant, it acts as a structuring agent and generally leads to structured materials, what will be explained hereafter.

The surfactant concentration in the solution, prior to depositing, is significantly lower than the critical micelle concentration. This sol is then deposited onto a substrate. During such deposition, the organic solvent does evaporate, thus increasing the water, surfactant and silica content in the film, whereby the critical micelle concentration is reached. As the solvent medium is highly polar, the surfactant molecules do aggregate, thus forming micelles orienting their polar heads towards the solvent.

The inorganic lattice (for example silica) expands then. Silica, also highly polar, does form a matrix around micelles rather than around distinct surfactant molecules. That thus leads to composite species consisting in organic micelles coated with mineral precursors. Said lattice expands and does entrap or encapsulate micelles inside the solid structure.

In a second stage, as evaporation goes on, the micelle shape may optionally change and the micelles self-organize in more or less ordered structures, forming for example a hexagonal, cubic or lamellar lattice until the film is dry.

The final arrangement of the resulting mineral matrix is governed by the shape of the micelles which are generated by the used amphiphilic molecules.

The pore size in the final material depends on the size of the pore-forming agent which is entrapped or encapsulated inside the silica lattice. When a surface active agent (surfactant) is used, the pore size in the solid is relatively large as the silica lattice is built up around the micelles, that is to say the colloidal particles, generated by the surfactant.

Intrinsically, micelles are larger in size as compared to their components, so that using a surfactant as a pore-forming agent does generally produce a mesoporous material.

When the pore-forming agent is not an amphiphilic agent, there are no micelles formed in the reaction conditions and no structured materials produced.

Once the inorganic lattice is formed around the mesopores containing the pore-forming agent, this pore-forming agent may optionally be removed from the material, whereby a mesoporous material is obtained. In the present application, a material may be considered as being mesoporous provided the pore-forming agent used for its preparation has been at least partially removed from at least part of this material, that is to say at least one part of this material comprises at least partially void mesopores.

Removing the pore-forming agent may be performed by calcination (heating to a temperature generally of about 400° C.), or using milder methods (solvent, supercritical fluid, UV/ozone or plasma extraction methods).

Instead of silica, other inorganic materials may be used, such as for example metal or metalloid oxide precursors, for example based on titanium, niobium or aluminum.

The mesoporous films described in the state of the art generally display high void ratios, i.e. higher than 40% by volume, these pores being filled with air, and possess properties resulting therefrom, especially a low refractive index and a low dielectric coefficient.

The preferred applications for these films relate to the electronic field.

Mesoporous materials may act as hosts for a large variety of guest chemical species having particular intrinsic properties, what may be used for imparting particular optical, electric, magnetic, chemical or catalytic properties to the material, depending on the nature of the chosen guest species. The present application does deal with the incorporation of photochromic compounds into the pores of such materials.

The “correct functioning” of a photochromic agent dispersed in a matrix, that is to say a normal photochromism, with fast colouring and bleaching kinetics, requires a hydrophobic environment devoid of steric stress.

When preparing photochromic films, the mechanical properties of the films should therefore be optimized while ensuring however that the photochrome is in a suitable environment for its colouring/bleaching functioning.

Various solutions have already been proposed to satisfy these requirements. First of all, it may be possible to incorporate the photochrome into an organic polymer. It is also possible to incorporate the photochrome into a “dense” sol-gel film. Generally, a sol which does not comprise any pore-forming agent is prepared, most often by simultaneously hydrolyzing and condensing various precursors. To this sol is added the photochrome, prior to depositing the film. The most interesting solutions as regards the photochrome functioning are provided by poorly crosslinked matrices, wherein the polymer chains are circulating at room temperature (Tg<0° C.), what lowers the steric stress. Unfortunately, these non mesoporous films are “soft” and display a low mechanical strenght. Examples of such films may be found in the French patent FR 2 795 085 and in the article “Spirooxazine- and spiropyran-doped hybrid organic-inorganic matrices with very fast photochromic responses”, Schaudel, B.; Guermeur, C.; Sanchez, C.; Nakatani K.; Delaire J.-A. J. Mater. Chem. 1997, 7, 61-65.

It is well known that the difficulty in obtaining a film with good mechanical properties while providing the photochrome with an environment promoting its colouring/bleaching functioning may be solved using a mesoporous material whose guest species is a photochromic material.

Indeed, the topology of the silica mesoporous films, with “soft” areas (in which is located the photochrome) within a rigid matrix, makes it possible to combine these two requirements. The soft areas ensure an environment promoting the photochrome functioning, that is to say the correct running of the opening and closing cycles. Fast colouring and bleaching kinetics, that can be compared to that observed in a solution, are obtained. The system performances are in this case only limited by the intrinsic features of the chosen photochromic molecule, which does behave as in a solvent medium.

In addition, the silica mesoporous structures, containing a pore-forming agent of the surfactant type, or not, have a good mechanical strength.

Two synthetic methods have been used in the state of the art to produce mesoporous or mesostructured photochromic films. These two methods, called impregnation and direct synthesis, will be explained hereafter.

Said impregnation method consists in impregnating a mesoporous film with a solution comprising a photochrome and is especially described in “Photochromism in spiropyran impregnated fluorinated mesoporous organosilicate films”, Bae, J. Y.; Jung, J. I.; Bae, B.-S. J. Mater. Res. 2004, 19, 2503-2509. In this article, a film comprising a hydrophobic matrix is prepared by an acid hydrolysis (HCl) and simultaneously a condensation of TEOS (Si(OEt)₄, silica precursor) and of a trialkoxy silane having a fluorinated aliphatic chain bound to silicon, in the presence of the CTAC (cetyl trimethylammonium chloride) surfactant, both silanes being used in a 9:1 ratio. A surfactant-containing mesostructured film is obtained after 24 hours reaction at room temperature. Thereafter, the surfactant is removed by calcination at 350° C., leading to an ordered mesoporous film, which is then impregnated for 12 hours by dipping in a photochromic solution (spiropyran) in ethanol.

A similar approach is employed in the patents JP 2000-226572 (Canon Inc.) and WO 02/41043, which consider the preparation of a silica matrix-based film (TMOS or TEOS precursor) or based on a transition metal, mesostructured by the CTAC surfactant or by a block copolymer-type surfactant. The latter may be removed by calcination at 550° C. or by low-temperature extraction (<110° C.) with a solvent (ethanol) or a supercritical fluid. A photochrome of the spiropyran type for example, is then incorporated by impregnation, providing a structured mesoporous photochromic film having good mechanical properties. Alternatively, as disclosed in the patent JP 2000-226572, the surfactant is not removed from the film structure before impregnation with a photochromic solution. The final material is then a mesostructured photochromic film.

The second main method for preparing mesoporous or mesostructured photochromic films is the so called “direct synthesis.” This method does consist in dissolving the photochrome in the film precursor sol in the presence of a pore-forming agent, then in depositing and polymerizing the sol. Generally, the pore-forming agent is not removed from the film structure.

The patent WO 02/41043 and the article “Fast response photochromic mesostructures”, Wirnsberger, G.; Scott, B. J.; Chmelka, B. F.; Stucky, G. D. Adv. Mater. 2000, 12, 1450-1454 describe the direct synthesis preparation of silica matrix-based films or transition metal-based films, mesostructured by a three block, polyethylene oxide-polypropylene oxide-polyethylene oxide copolymer-type surfactant. The film is several-micrometer thick. The mole ratio photochrome:Si does generally range from 1.5.10⁻³ to 3.5.10⁻³. The patent WO 02/41043 also describes the photochrome covalent anchorage to the silica matrix or to the three-block copolymer during the direct synthesis, using a derivatized photochrome bearing a trialkoxysilane function, for example, which can create siloxane bridges with the lattice precursors or the already synthesized matrix. However, the anchorage to the matrix by a covalent bond cannot be dissociated from a decrease in the photochrome efficiency because the latter is stressed.

The incorporation of photochromes into a mesostructured silica powder comprising a surfactant in its structure is described in the article “Photochromic mesostructured silica pigments dispersed in latex films”, Andersson, N.; Alberius, P.; Ortegren, J.; Lingren, M.; Bergstrõm, L. J. Mater. Chem. 2005, 15, 3507-3513. The photochrome is added to a surfactant (PE10400) before the powder preparation, so that it seems to be finally located in the hydrophobic part of the micelles. In a second stage, the powder is dispersed in an organic polymer suspension (latex) and the whole is deposited in the form of films with a thickness ranging from 70 to 150 μm.

The removal at a low temperature, that is to say lower than or equal to 150° C., of a pore-forming agent incorporated into a hydrophobic matrix-based mesostructured material is therefore not described. The state of the art describes or only suggests low temperature removal methods in the case of pore-forming agents incorporated into silica matrix-based or transition metal oxide-based mesostructured materials. In addition to the hereabove mentioned patents, it may especially be referred to the U.S. Pat. No. 5,858,457.

The removal of a pore-forming agent incorporated into a hydrophobic matrix-based mesostructured material is systematically conducted by calcining the material at high temperature (350-500° C.), generally under an oxygen or an air flow, sometimes for several hours, in the hereabove mentioned patents and especially in the patent applications WO 03/024869 and US 2003/157311.

However it would be desirable to have a method for preparing mesoporous photochromic films by impregnation, based on the removal of the pore-forming agent under mild conditions, because methods which do imply a calcination step are not suitable for treating organic substrates which would be damaged by the calcination high temperatures, especially transparent organic substrates, such as optical or ophthalmic lenses. In addition, submitting mesostructured films to high temperatures may cause the structure to collapse due to the high deformations resulting from these treatments.

A further drawback of such methods which do imply calcination is a high energetic expenditure, which makes expensive these methods for making mesoporous films.

Moreover, the state of the art does not describe any preparation of hydrophobic matrix-based photochromic materials (silica matrix modified by an organic group during or subsequent to the lattice formation) implying a direct synthesis. Direct synthesis is only reported for preparations of non-modified silica matrix-based photochromic materials (or of photochromic materials based on another metal or metalloid which does not bear hydrophobic groups).

One of the drawbacks of such silica matrix-based mesoporous films is their poor stability under a highly humid atmosphere. These films tend to become charged with water as time goes by, what modifies their initial properties.

The difficulty to maintain the stability of the mesoporous or mesostructured films optical properties is particularly important if those have to be used in the optical field, because, in opposition to semiconductor field applications, wherein dielectric coefficient variations within predetermined limits may be considered without affecting the semiconductor functioning, very small variations of the refractive index have an immediately perceptible consequence in the optical field, for example by modifying the coating colours and performances. It thus appears that the silica matrix-based films obtained according to the method described in the U.S. Pat. No. 5,858,457 rapidly change as time goes by, in particular under a humid atmosphere and cannot be used in practice.

It would thus be desirable to be provided with photochromic films (or layers) having an improved stability over time, in particular for applications in the optical field, and more specifically in ophthalmic optics.

It is moreover very difficult to obtain optical grade photochromic films. On the one hand, it is necessary to obtain a perfectly homogeneous distribution of the photochromic compounds within the film itself, which should not exhibit any light diffusion characteristics. On the other hand, the photochromic compound properties should not be altered, or at least not altered to such an extent that photochromism would no more be exploitable, either because of a loss of the photochromic properties (kinetics, colourability), or because of the loss of a photochromic compound due to a damage occurring in particular during the film preparation. This problem is all the more crucial for photochromic compounds of the spirooxazine type, which are sensitive to their environment, in particular to the acidity of the medium where they are dissolved, and very sensitive to heat. Lastly, the films obtained should be stable over time, in particular as regards their photochromic properties.

The present invention therefore aims at providing methods for making substrates coated with photochromic, especially mesoporous, films having a hydrophobic matrix, which solve the hereabove mentioned technical problems and which may in particular apply to any type of substrate and especially to transparent substrates made of heat-sensitive, organic materials.

The invention aims at providing methods which moreover prevent any risk of impairment of the photochromic compound photochromic properties during the film preparation, while ensuring a homogeneous distribution of said photochromic compound within the film. Incorporating the photochrome into the hydrophobic matrix should be carried out without impairing the stability of the resulting structure.

The invention further aims at providing methods such as hereabove mentioned, wherein the photochromic compound displays kinetic constants close to that observed in a solvent medium.

Lastly, the invention aims at providing a substrate coated with a film such as hereabove mentioned, in particular an optical or ophthalmic lens.

The hereabove mentioned objectives are reached, according to the invention, by a first method for making a substrate coated with a mesoporous photochromic film, comprising:
a) preparing a precursor sol of a mesoporous film comprising:
   an inorganic precursor agent selected from compounds of formula:

M(X)₄ (I)
wherein the X groups, being the same or different, are hydrolyzable groups preferably selected from alkoxy, acyloxy and halogen groups, preferably alkoxy, and M is a tetravalent metal or metalloid, preferably silicon;
at least one organic solvent;
at least one pore-forming agent;
water;
and optionally a catalyst for hydrolyzing the X groups;
b) depositing a film of the precursor sol onto a main surface of a substrate;
c) optionally, consolidating the deposited film;
d) removing the pore-forming agent from the film resulting from the previous step and forming a mesoporous film;
e) impregnating the mesoporous film resulting from step d) with a solution comprising at least one photochromic agent; and
f) recovering a substrate coated with a mesoporous photochromic film; said method being characterized in that:
   (i) the removal of the pore-forming agent is conducted at a temperature ≦150° C., preferably 130° C., more preferably ≦120° C. and even more preferably ≦110° C.; and
   (ii) said method comprises a step of introducing at least one hydrophobic precursor agent bearing at least one hydrophobic group into the precursor sol prior to step b) of depositing the precursor sol film.

The invention also relates to a second method for making a substrate coated with a photochromic film, comprising:
a) preparing a precursor sol of a photochromic film comprising:
   an inorganic precursor agent selected from compounds of formula:

M(X)₄ (I)
wherein the X groups, being the same or different, are hydrolyzable groups
preferably selected from alkoxy, acyloxy and halogen groups, preferably alkoxy,
and M is a tetravalent metal or metalloid, preferably silicon;
at least one organic solvent;
at least one pore-forming agent;
at least one photochromic agent;
water;
and optionally a catalyst for hydrolyzing the X groups;
b) depositing a film of the precursor sol onto a main surface of a substrate and forming a photochromic film;
c) optionally, consolidating the deposited photochromic film; and
d) recovering a substrate coated with a photochromic film;
   said method being characterized in that it comprises a step of introducing at least one hydrophobic precursor agent bearing at least one hydrophobic group into the precursor sol prior to step b) of depositing the precursor sol film.

The invention further relates to a third method for making a substrate coated with a photochromic film, comprising:
a) preparing a precursor sol of a photochromic film comprising:
   an inorganic precursor agent selected from compounds of formula:

M(X)₄ (I)
wherein the X groups, being the same or different, are hydrolyzable groups preferably selected from alkoxy, acyloxy and halogen groups, preferably alkoxy, and M is a tetravalent metal or metalloid, preferably silicon;
at least one organic solvent;
at least one pore-forming agent;
at least one photochromic agent;
water;
and optionally a catalyst for hydrolyzing the X groups;
b) depositing a film of the precursor sol onto a main surface of a substrate and forming a photochromic film;
c) optionally, consolidating the deposited photochromic film; and
d) recovering a substrate coated with a photochromic film;
   said method being characterized in that it comprises a step of treating the film subsequently to step b) or if present, subsequently to step c), with at least one hydrophobic reactive compound bearing at least one hydrophobic group.

The invention will be described in more detail with reference to the appended drawings, amongst which:

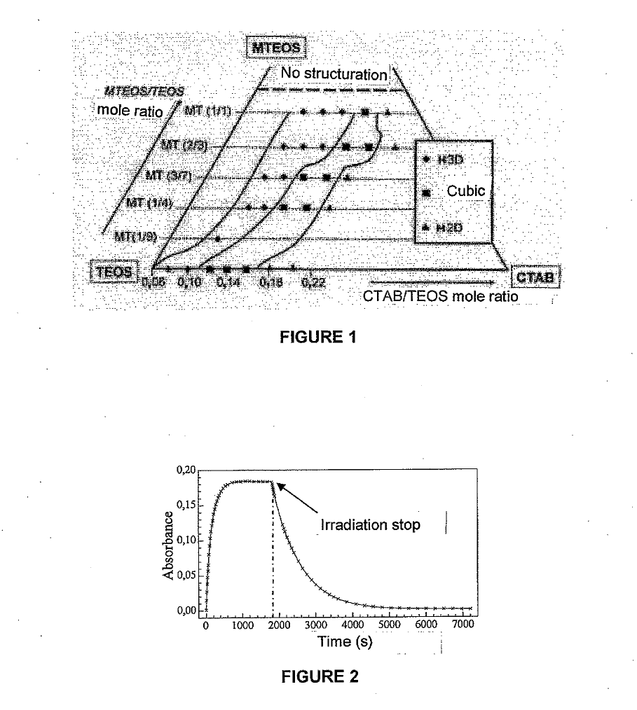

FIG. 1 shows part of the ternary diagram of the phases obtained in TEOS/MTEOS/CTAB films, making it thus possible to determine the ordered, or not, structure of a film of the invention prepared from the pore-forming agent CTAB, the inorganic precursor agent TEOS and the hydrophobic precursor agent MTEOS. These compounds are detailed in the following description.

FIG. 2 shows a spectrum example illustrating the absorbance variation vs. time of a photochromic film submitted to an UV irradiation which was immediately interrupted as soon as the film maximal absorbance was reached, making it thus possible to determine the kinetic constant of bleaching in the dark of the photochrome incorporated into the mesoporous film.

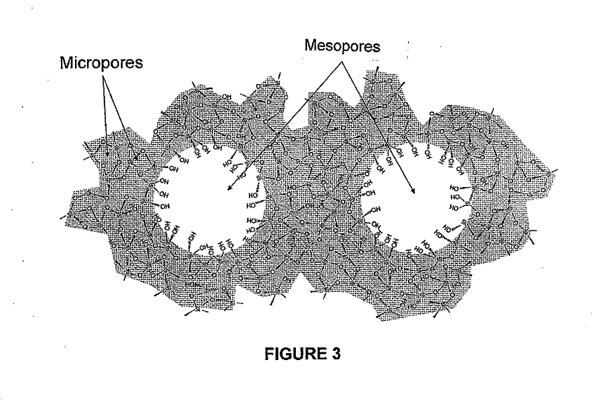

FIG. 3 is a schematic view of the morphology of a silica matrix-based mesoporous film obtained after removal of the pore-forming agent. This is not a mesoporous film according to the invention. However, a hydrophobic matrix-based mesoporous film of the invention does contain approximately the same amount of micropores and mesopores as the silica-based film shown on FIG. 3.

In the present invention, “hydrophobic” groups are intended to mean atom combinations which can not bind to water molecules, especially through hydrogen bonding. Said groups are generally organic, non polar groups, without any charged atoms. Alkyl, phenyl, fluoroalkyl, (poly)fluoro alkoxy[(poly)alkylenoxy]alkyl groups and the hydrogen atom therefore belong to this class.

Preferably, all the steps of the three methods of the invention are conducted at a temperature ≦150° C., preferably ≦130° C., more preferably ≦120° C. and even more preferably ≦110° C.

The first method of the invention will be first described.

Precursor sols of mesoporous films are well known and do generally comprise at least one inorganic precursor agent of formula (I) or one hydrolyzate thereof, at least one organic solvent, one pore-forming agent and water, the medium containing the precursor agent of formula (I) being generally an acidic medium, said acidic character of the medium being obtained by adding, for example a mineral acid, generally HCl or an organic acid such as acetic acid, preferably HCl. This acid acts as a condensation catalyst by catalyzing the hydrolysis of the X groups of the compound of formula (I).

In the present invention, this precursor sol further comprises at least one hydrophobic precursor agent bearing at least one hydrophobic group, which is generally introduced into the precursor sol in the form of a solution in an organic solvent.

The inorganic precursor agent of formula (I) and the hydrophobic precursor agent both are the two precursor agents of the film matrix, whose walls will enclose the mesopores in the final mesoporous film. As used herein, an “inorganic precursor agent” is intended to mean an organic or inorganic agent which, if polymerized alone, would produce an inorganic matrix.

According to the first method of the invention (impregnation), a substrate coated with a mesoporous photochromic film may be obtained by dissolving at least one inorganic precursor agent of formula (I), at least one hydrophobic precursor agent and at least one pore-forming agent in a mixture of water and organic solvent, generally in a water-alcohol medium. In some cases, a heating may be conducted to help dissolving the various compounds. Once all the components have been dissolved, the sol, if necessary, is cooled and is stirred under conditions which are sufficient (under heating if required) to enable a co-condensation of the precursors and optionally the formation, prior to depositing, of colloidal particles comprising the pore-forming agent dispersed within the expanding lattice. It should be noted that in the case of a pore-forming agent of the surfactant type, the formation of the colloidal particles (micelles) does occur during the deposition step.

At the end of this polymerization step leading to a composite, the pore-forming agent is removed, providing a mesoporous film with air-filled pores, which is optionally structured (which is possible only if the pore-forming agent is of the amphiphilic type) and which is subsequently impregnated with a solution containing at least one photochrome. A mesoporous photochromic film is obtained if the pore-forming agent is not of the amphiphilic type, and a generally structured, mesoporous photochromic film if the pore-forming agent is of the amphiphilic type.

As hereabove indicated, the inorganic precursor agent is selected from organometallic or organometalloid compounds and mixtures thereof of formula:

M(X)₄ (I)

wherein M is a tetravalent metal or metalloid and the X groups, being the same or different, are hydrolyzable groups preferably selected from —O—R alkoxy groups, in particular C₁-C₄ alkoxy groups, or —O—C(O)R acyloxy groups, where R is an alkyl radical, preferably a C₁-C₆ alkyl radical, preferably a methyl or ethyl radical, halogens such as Cl, Br and I, and combinations of these groups. Preferably, the X groups are alkoxy groups, and in particular methoxy or ethoxy groups, and more preferably ethoxy groups, what makes the inorganic precursor agent (I) a metal or a metalloid alcoholate.

Tetravalent metals corresponding to M include for example metals such as Sn or transition metals such as Zr, Hf or Ti. M preferably represents silicon and if so, the compound (I) is the precursor of a silica-based matrix or of a matrix based on at least one metal silicate.

Preferred compounds (I) are tetraalkyl orthosilicates. Amongst them, tetraethoxysilane (or tetraethyl orthosilicate) Si(OC₂H₆)₄ noted TEOS, tetramethoxysilane Si(OCH₃)₄ noted TMOS, or tetrapropoxysilane Si(OC₃H₇)₄ noted TPOS are advantageously used, and TEOS is preferably used.

The inorganic precursor agents of formula (I) included in the sol generally represent from 10 to 30% by mass as related to the precursor sol total mass.

The hydrophobic precursor agent is preferably selected from compounds and mixtures of compounds of formula (II) or (III):

(R¹)ₙ₁(R²)ₙ₂M (II)

or

(R³)ₙ₃(R⁴)ₙ₄M-R′-M(R⁵)ₙ₅(R⁶)ₙ₆ (III)

wherein:
M is a tetravalent metal or metalloid, preferably Si, Sn, Zr, Hf or Ti, more preferably silicon;
R¹, R³ and R⁵, being the same or different, represent saturated or unsaturated, preferably C₁-C₈ and more preferably C₁-C₄, hydrocarbon hydrophobic groups, for example alkyl groups, such as methyl or ethyl groups, vinyl groups, aryl groups, for example phenyl groups, optionally substituted, in particular by one or more C₁-C₄ alkyl groups, or represent fluorinated or perfluorinated analogous groups of the previously mentioned hydrocarbon groups, for example fluoroalkyl or perfluoroalkyl groups, or (poly)fluoro or perfluoro alkoxy[(poly)alkylenoxy]alkyl groups. Preferably R¹, R³ and R⁵ represent methyl groups.
R², R⁴ and R⁶, being the same or different, represent hydrolyzable groups, preferably selected from —O—R alkoxy groups, in particular C₁-C₄ alkoxy groups, or —O—C(O)R acyloxy groups, where R is an alkyl radical, preferably a C₁-C₆ alkyl radical, preferably a methyl or ethyl radical, and halogens such as Cl, Br and I. Said groups are preferably alkoxy groups, in particular methoxy or ethoxy groups, and more preferably ethoxy groups.
R′ is a divalent group, for example a linear or branched, optionally substituted, alkylene group, an optionally substituted cycloalkylene group, an optionally substituted arylene group, or a combination of the previously mentioned groups of the same class and/or of different classes, especially a cycloalkylene alkylene, a biscycloalkylene, a biscycloalkylene alkylene, an arylene alkylene, a bisphenylene and a bisphenylene alkylene group. Preferred alkylene groups include linear C₁-C₁₀ alkylene groups, for example methylene group —CH₂—, ethylene group —CH₂—CH₂—, butylenes and hexylene groups, especially 1,4-butylene and 1,6-hexylene groups, and branched C₃-C₁₀ alkylene radicals such as 1,4-(4-methyl pentylene), 1,6-(2,2,4-trimethyl hexylene), 1,5-(5-methyl hexylene), 1,6-(6-methyl heptylene), 1,5-(2,2,5-trimethyl hexylene), 1,7-(3,7-dimethyl octylene), 2,2-(dimethylpropylene) and 1,6-(2,4,4-trimethyl hexylene) radicals. Preferred cycloalkylene radicals include cyclopentylene and cyclohexylene radicals, optionally substituted, especially with alkyl groups. R′ preferably represents a methylene, an ethylene or a phenylene group.
n₁ is an integer ranging from 1 to 3, n₂ is an integer ranging from 1 to 3, n₁+n₂=4,
n₃, n₄, n₅, and n₆ are integers ranging from 0 to 3 provided that the sums of n₃+n₆ and n₄+n₆ are different from zero, and n₃+n₄=n₅+n₆=3.

Preferred hydrophobic precursor agents include alkyl alkoxysilanes, especially alkyl trialkoxysilanes such as methyl triethoxysilane (MTEOS, CH₃Si(OC₂H₆)₃), vinyl alkoxysilanes, especially vinyl trialkoxysilanes such as vinyl triethoxysilane, fluoroalkyl alkoxysilanes, especially fluoroalkyl trialkoxysilanes such as 3,3,3-trifluoropropyl trimethoxysilane of formula CF₃CH₂CH₂Si(OCH₃)₃, and aryl alkoxysilanes, especially aryl trialkoxysilanes. Dialkyl dialkoxysilanes such as dimethyl diethoxysilane may also be used. Methyl triethoxysilane (MTEOS) is the particularly preferred hydrophobic precursor agent.

Generally speaking, the mole ratio of the hydrophobic precursor agent to the inorganic precursor agent of formula (I) does vary from 10:90 to 50:50, more preferably from 20:80 to 45:55, and is preferably equal to 40:60, in particular when using MTEOS as the hydrophobic precursor agent in the precursor sol.

Generally, the hydrophobic precursor agent bearing at least one hydrophobic group represents from 1 to 50% by mass as related to the precursor sol total mass.

The organic solvents or the mixture of organic solvents suitable for preparing the precursor sol of the invention are all traditionally used solvents and more particularly polar solvents, especially alkanols such as methanol, ethanol, isopropanol, isobutanol, n-butanol and mixtures thereof. Other solvents, preferably water-soluble solvents, such as 1,4-dioxane, tetrahydrofurane or acetonitrile, may be used. Ethanol is the most preferred organic solvent.

Generally speaking, the organic solvent represents from 40 to 90% by mass as related to the precursor sol total mass.

Water included in the precursor sol generally represents from 10 to 20% by mass as related to the precursor sol total mass.

The pore-forming agent of the precursor sol may be an amphiphilic or a non-amphiphilic pore-forming agent. Generally, it is an organic compound. It may be used either alone or in admixture with other pore-forming agents.

Non amphiphilic pore-forming agents to be suitably used in the present invention include:
synthetic polymers such as polyethylene oxide, with a molecular mass ranging from 50000 to 300000, polyethylene glycol, with a molecular mass ranging from 50000 to 300000,
gamma-cyclodextrin, lactic acid, and other biological materials such as proteins or sugars such as D-glucose or maltose.

The pore-forming agent is preferably an amphiphilic compound of the surfactant type. One of the main characteristics of such a compound is its ability to form micelles in a solution, subsequent to solvent evaporation which concentrates the solution, leading to the formation of a mineral matrix-based mesostructured film. It thus acts as a structuring agent.

Surfactants may be non ionic, cationic, anionic or amphoteric. These surfactants are for most of them commercially available.

Ionic surfactants include sodium dodecylbenzene sulfonate, ethoxylated fatty alcohol sulfates, cetyl trimethylammonium bromide (CTAB), cetyl trimethylammonium chloride (CTAC), sodium dodecylsulfate (SDS), and azobiscyanopentanoic acid.

Non ionic surfactants include ethoxylated fatty alcohols, ethoxylated acetylene diols, compounds of the block copolymer type comprising both hydrophilic and hydrophobic blocks, poly(alkylenoxy)alkyl-ethers and surfactants comprising a sorbitan group.

Amongst the block copolymer type surfactants, three-blocks are preferably used, wherein a polyalkylene oxide hydrophobic block with an alkylene oxide moiety comprising at least three carbon atoms, such as a polypropylene oxide block, is linearly and covalently bonded at both ends thereof to a hydrophilic polyalkylene oxide block such as a polyethylene oxide block, or two-block type copolymers wherein, for example, a polyethylene oxide block is linearly and covalently bonded to a polybutylene oxide or polypropylene oxide block. Suitable examples thereof include polyoxyethylene-polyoxypropylene-polyoxyethylene (PEO-PPO-PEO) such as those described by Zhao and al. in J. Am. Chem. Soc. 1998, 120, 6024-6036, or those marketed by BASF under the trade name PLURONIC®, noted (EO)ₓ—(PO)_{y}-(EO)_{z} or HO(CH₂CH₂O)ₓ—(CH₂CH(CH₃)O)_{y}—(CH₂CH₂O)_{z}H, or polyoxyethylene-polyoxybutylene-polyoxyethylene (PEO-PBO-PEO) noted (EO)ₓ—(BO)_{y}-(EO)_{z} or HO(CH₂CH₂O)ₓ—(CH₂CH(CH₃CH₂)O)_{y}—(CH₂CH₂O)_{z}H, or branched PEO-PPO block copolymers marketed by BASF under the trade name TETRONIC®, which are tetrafunctional block copolymers resulting from the sequential addition of propylene oxide and ethylene oxide on ethylene diamine. In the hereabove formulas, x and z are preferably higher than 5, y is preferably higher than 20.

Specific examples of the hereabove compounds include PE6800 of formula (EO)₇₃—(PO)₂₈-(EO)₇₃ and PE10400 of formula (EO)₂₇—(PO)₆₁-(EO)₂₇, Tetronic 908 (also named Poloxamine 908), and Pluronic F68, F77, and F108. Three-block copolymers in a reversed order as compared to those hereabove described may also be used, for example PPO-PEO-PPO three-block copolymers.

Amongst the poly(alkylenoxy)alkyl-ether type surfactants, poly(ethylenoxy)alkyl-ethers of general formula CₙH₂₊₁(OCH₂CH₂)ₓOH are preferred, especially those wherein n≧12 and ≧8, for example the surfactants marketed by ICI under the trade name BRIJ®, such as BRIJ 56® (C₁₆H₃₃(OCH₂CH₂)₁₀OH), BRIJ 58® (C₁₆H₃₃(OCH₂CH₂)₂₀OH) and BRIJ 76® (polyoxyethylene (10) stearyl ether or C₁₈H₃₇(OCH₂CH₂)₁₀OH).

Amongst the surfactants comprising a sorbitan group, the surfactants marketed by ICI under the trade name TWEEN®, which are polyoxyethylene sorbitans esterified by fatty acids, or the surfactants marketed by Aldrich Chem. Co. under the trade name SPAN®, whose sorbitan head has been esterified by fatty acids, may be used.

Preferred pore-forming agents are CTAB and ethylene oxide and propylene oxide two-block or three-block copolymers, preferably three-block copolymers.

Generally speaking, the pore-forming agent represents from 2 to 10% as related to the precursor sol total mass. Generally, the mass ratio of the pore-forming agents to both the precursor agents of formula (I) and the hydrophobic precursor agents bearing at least one hydrophobic group added to the precursor sol, does vary from 0.01 to 5, preferably from 0.05 to 1.

A particularly recommended method for making the precursor sol of a mesoporous film according to the first method of the invention (step a)) is a method for incorporating the precursor agents in two steps, comprising a first step of pre-hydrolysis and condensation, generally in the presence of an acid catalyst, of the inorganic precursor agent of formula (I) such as previously defined (forming what will be called a “silica sol” when the inorganic precursor agent of formula (I) is a silica precursor), followed by a second step of admixing the hydrophobic precursor agent, with an optionally simultaneous introduction of the pore-forming agent.

Such a two-step hydrolysis advantageously enables to introduce high amounts of the hydrophobic precursor agent and to reach a mole ratio of the hydrophobic precursor agent to the inorganic precursor agent of formula (I) as high as 50:50, while preserving an ordered structure within the film.

The hydrolysis is conducted in an acidic medium, by adding water to a pH value generally lower than 4, more preferably lower than 2, and most often between 1 and 2.

During the first step, the hydrolysis of the M(X)₄ compound is preferably performed in the presence of a slight excess of water, generally a water amount which is from more than 1 time to 1.5 times the water molar amount required for a stoichiometric hydrolysis of the M(X)₄ compound hydrolyzable moieties. The reaction is then allowed to proceed (sol aging). During this procedure, the sol is preferably maintained at a temperature of about 50 to 70° C., generally of 60° C., for 30 minutes to 2 hours. Condensation may also be conducted at lower temperatures, but with longer condensation time periods.

Yet preferably, quickly after the hydrophobic precursor agent has been introduced into the precursor sol, preferably within 5 minutes or less, and more preferably within two minutes or less subsequent to the hydrophobic precursor agent introduction, should the precursor sol be deposited and the precursor sol film be formed. Working within this very short time period enables to minimize the condensation reaction of the hydrophobic precursor agent prior to depositing and forming the film. In other words, a partial hydrolysis of the hydrophobic precursor agent is simply induced without causing any significant formation of condensed species from this agent.

The step b) of depositing the precursor sol film onto the substrate main surface may be performed using any traditional method, such as for example immersion deposition, spray deposition or spin coating, preferably spin coating. Preferably, deposition step b) is conducted under an atmosphere with a relative humidity (RH) varying from 40 to 80%.

The step c) of consolidating the film structure of the deposited precursor sol consists in optionally completing the removal of the solvent or mixture of organic solvents and/or of the possible water excess from the precursor sol film, and in carrying condensation on, for example of the residual silanol groups which are present in the sol if using a silica-based matrix, generally by heating said film. Preferably, step c) is performed by heating at a temperature ≦150° C., preferably ≦130° C., more preferably ≦120° C. and even more preferably ≦110° C.

During step d), the pore-forming agent may be partly or completely removed. Preferably, step d) does remove at least 90% by mass of the total mass of the pore-forming agent present in the film resulting from the previous step, more preferably at least 95% by mass and even more preferably at least 99% by mass. Such removal is performed by any suitable method enabling to work at low temperatures, that is to say at a temperature ≦150° C., preferably ≦130° C., more preferably ≦120° C. and even more preferably ≦110° C. Well known methods such as solvent or supercritical fluid extraction methods, ozone degradation methods, plasma treatment, for example by an oxygen or argon plasma, or corona discharge treatment, or photodegradation methods by exposure to a luminous radiation, may be especially mentioned. The latter is for example described in the application US 2004/0151651. A supercritical fluid extraction (generally supercritical CO₂) of a surfactant within a mesostructured material is performed for example in the patent JP 2000-226572.

The removal of the pore-forming agent will be preferably performed by extraction. Several successive extractions may be performed, so as to reach the expected extraction degree.

Preferably, the extraction is carried out in an organic solvent or in a mixture of organic solvents, by dipping the formed and optionally consolidated film in a preferably organic solvent or mixture of solvents, heated to a temperature ≦150° C. A reflux solvent will be preferably used. Any solvent with a boiling point ≦150° C., preferably ≦130° C., more preferably ≦120° C. and even more preferably ≦110° C., may be suitable. Preferred solvents include alkanols, especially ethanol (boiling point=78° C.), alkyl ketones, especially acetone (boiling point=56° C.) and chloroalkanes such as dichloromethane or chloroform. A non toxic solvent such as acetone or ethanol will be preferably used. Acetone is particularly well suited for the removal by solubilization of surfactants of the CTAB or CTAC type. Solvent extraction may also be efficiently performed at room temperature, under stirring, using ultrasounds.

Extracting the pore-forming agent by means of an organic solvent makes it possible to better control the final thickness of the mesoporous film than would be the case with a calcination-based method.

Photochromic compounds to be suitably used in the present invention generally are organic compounds, and usually hydrophobic compounds. A compound having photochromic properties is defined as being a compound which may undergo a reversible chemical conversion by photoirradiation, whereby it is converted from a first form to a second form having a different absorption spectrum.

Photochromic agents to be suitably used in the context of the present invention include compounds which, when excited by a luminous radiation, display at least one maximum absorption wavelength in the range of 400-700 nm.

The photochromic agents incorporated into the films made in accordance with the method of the present invention may be, without limitation, oxazine derivatives, in particular spirooxazines, chromenes, chromene-derived photochromic compounds such as pyrans, in particular spiropyrans, fulgides and fulgimides, and dithizonate organometallic derivatives, as well as mixtures thereof.

Compounds comprising an oxazine moiety, in particular spirooxazines are well known photochromic compounds. They are described, inter alia, in the following documents U.S. Pat. No. 4,562,172, U.S. Pat. No. 3,578,602, U.S. Pat. No. 4,215,010, U.S. Pat. No. 4,720,547, U.S. Pat. No. 5,139,707, U.S. Pat. No. 5,114,621, U.S. Pat. No. 5,529,725, U.S. Pat. No. 5,645,767, U.S. Pat. No. 5,658,501, WO 87/00524, WO 96/04590, JP 03251587, FR 2647789, FR 2647790, FR 2763070, EP 0245020 and EP 0783483.

Preferred oxazine compounds are compounds of the spiro[indolino]benzoxazine, spiro[indolino]naphthoxazine and spiro[indolino]pyridobenzoxazine type. Preferred oxazine compounds include compounds comprising the following base moiety:

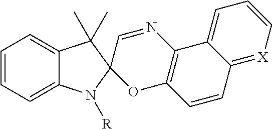

wherein R represents a linear or branched alkyl group, and X is a carbon or a nitrogen atom. The aromatic positions of this compound may be substituted. Specific examples of such compounds are the following compounds of formulas (IV) to (VI):

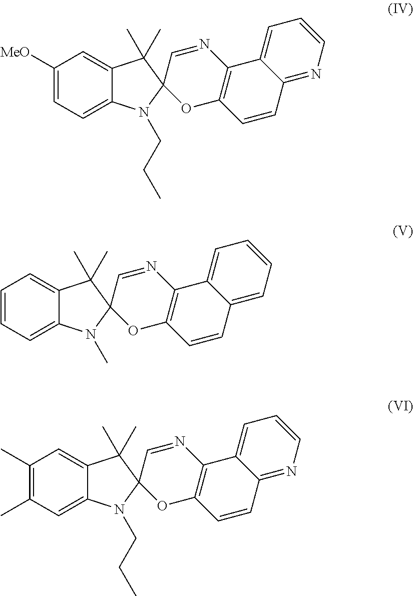 [SMILES: CCCN1c2ccc(OC)cc2C(C)(C)C12C=Nc1c(ccc3ncccc13)O2 ; CN1c2ccccc2C(C)(C)C12C=Nc1c(ccc3ccccc13)O2 ; CCCN1c2cc(C)c(C)cc2C(C)(C)C12C=Nc1c(ccc3ncccc13)O2]

Chromenes and chromene-derived photochromic compounds are also well known and are described, inter alia, in the documents EP 0246114, EP 0401958, EP 0562915, EP 0629656, EP 0676401, FR 2688782, FR 2718447, WO 90/07507, WO91/06861, WO 93/17071, WO 94/20869, U.S. Pat. No. 3,567,605, U.S. Pat. No. 5,066,818, U.S. Pat. No. 5,395,567, U.S. Pat. No. 5,451,344, U.S. Pat. No. 5,645,767, U.S. Pat. No. 5,656,206 and U.S. Pat. No. 5,658,501.

Chromene has the following structure:

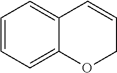

Preferred photochromic compounds comprising a chromene moiety may be illustrated by the following formula:

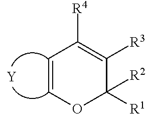

wherein the fragment:

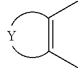

represents an optionally substituted, aromatic hydrocarbon radical or an optionally substituted unsaturated heterocyclic radical, R¹ and R² represent radicals, being the same or different, selected from a hydrogen atom, an optionally substituted hydrocarbon radical and a substituted amino radical, or combine to form a ring, and R³ and R⁴ represent radicals, being the same or different, selected from a hydrogen atom, an optionally substituted hydrocarbon radical and a substituted amino radical.

Amongst these compounds, a first preferred class is that of the naphthopyrans, in particular those having two substituted or not phenyl moieties on the carbon atom in a position adjacent to the oxygen atom of the pyran ring. Such photochromic compounds display an excellent resistance towards degradation induced by radicals in aqueous medium. An example thereof is the following compound (VII):

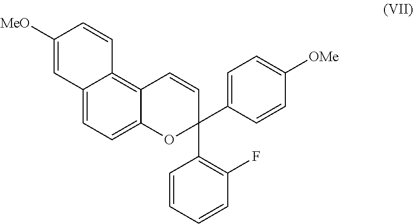 [SMILES: COc1ccc(C2(c3ccccc3F)C=Cc3c(ccc4cc(OC)ccc34)O2)cc1]

A second preferred chromene derivative class is that of spiropyrans. The preferred spiropyrans comprise the following base moiety:

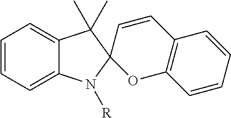

wherein R represents a linear or a branched alkyl group. The aromatic positions of this compound may be substituted. Example thereof is the following compound (VIII):

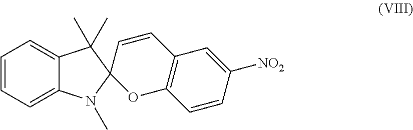 [SMILES: CN1c2ccccc2C(C)(C)C12C=Cc1cc([N+](=O)[O-])ccc1O2]

Fulgide and fulgimide photochromic compounds are compounds which are well known and described inter alia in the U.S. Pat. No. 4,931,220 and EP 0629656.

Dithizonate organometallic compounds as well are well known and described in the patent U.S. Pat. No. 3,361,706.

Preferred photochromic compounds are chromene derivatives and oxazine derivatives such as benzoxazines and naphthoxazines, in particular spirooxazine derivatives of the spiro[indolino]benzoxazine, spiro[indolino]naphthoxazine and spiro[indolino]pyridobenzoxazine type.

Incorporating the photochrome into the film may be performed post-synthesis by impregnation, using as a host an already formed mesoporous film (first method of the invention) or during the film synthesis itself (second and third methods of the invention, which will be described hereafter).

In the first method of the invention, the mesoporous film resulting from step d) is impregnated with a solution of at least one photochromic agent dissolved in an organic solvent or mixture of solvents. Said solvent should be able to create favorable interactions with the mesoporous matrix so as to ensure a good diffusion of the photochromic agent within the matrix. Suitable solvents especially include N,N-dimethyl formamide (DMF), tetrahydrofurane (THF), ethanol, cyclohexane, N-methylpyrrolidone (NMP), and more generally any appropriate solvent for photochromes (alkanes, xylenes, toluene . . . ). The photochromic agent solution may comprise as an additive a photochromic compound stabilizing agent.

The impregnation of the film may be performed, without limitation, by dipping the substrate coated with the film in a photochromic agent solution, or by spin coating a photochromic solution onto the mesoporous film. At the end of this impregnation step, the substrate coated with a photochromic mesoporous film is recovered.

The film is impregnated with the impregnation solution so as to obtain in the final film the expected photochromic effect. Generally, the mass of the photochromic agent introduced into the film represents from 1 to 10% of the mass of the mesoporous film obtained after removal of the pore-forming agent and before the impregnation step. The mass of the photochromic agent introduced into the film upon impregnation may be measured by conducting its extraction, for example by dipping the photochromic film in a solvent.

Any traditional photochromic agent may be used in the method of the invention, either alone or in admixture with other photochromic compounds, as long as they can be solubilized in a solvent or in a mixture of solvents, so that a solution for impregnating the mesoporous film of the invention can be prepared.

According to one embodiment of the invention, the first method of the invention further comprises a step of treating the film subsequently to step b) or if present, subsequently to step c), with at least one hydrophobic reactive compound bearing at least one hydrophobic group, said hydrophobic reactive compound being different from said hydrophobic precursor agent.

Such a step is intended to improve the hydrophobic character of the film. Various approaches thereof can be found in the literature.

The patent application US 2003/157311 describes the post-treatment of a mesoporous film (after removal of the pore-forming agent) with hexamethyl disilazane (HMDS), applied in a liquid phase, and followed with a heating step at 350° C. The objective of this HMDS post-treatment is to limit the water amount adsorbed into the mesoporous material pores, so as to maintain a low dielectric constant.

The patent application WO 99/09383 also describes the post-treatment of a TEOS mesoporous gel with trimethyl chlorosilane, after a solvent exchange was made on the gel. After this post-treatment, the gel is dissolved again as a consequence of a ultrasonic treatment, deposited onto a substrate, then calcinated for one hour at 450° C.

Such methods reveal unsuitable for treating organic substrates which would be damaged by the calcination high temperatures. In the present invention, the post-treatment additional step using said hydrophobic reactive compound is conducted at a temperature ≦150° C., preferably ≦130° C., more preferably ≦120° C. and even more preferably ≦110° C.

Treating the film with the hydrophobic reactive compound or the mixture of hydrophobic reactive compounds is conducted, according to the invention, preferably by contacting the hydrophobic reactive compound or the mixture of hydrophobic reactive compounds in a liquid or a vapor state, preferably in a vapor state, with said film. In a liquid phase, the hydrophobic reactive compound may be advantageously dissolved in a solvent and this solution brought to reflux, the film to be treated having been previously dipped therein.

If using a silica-based matrix, the hydrophobic reactive compound is reactive against silanol groups. It is possible to use the hydrophobic reactive compound in a large excess as compared to the number of silanol groups to be grafted to accelerate the reaction.

In a first alternative method, this additional step, called “post-synthetic grafting”, is conducted during the step d) of removing the pore-forming agent. This alternative method is particularly suitable when this step d) is a solvent extraction step. Thus, both treatments may be combined using a solution of a hydrophobic reactive agent bearing at least one hydrophobic group in a pore-forming agent extraction solvent.

In a second alternative method, the post-synthetic grafting additional step is conducted subsequently to the step d) of removing the pore-forming agent but prior to the impregnation step e).

In a third alternative method, the post-synthetic grafting additional step is conducted subsequent to the impregnation step e), that is to say on a film wherein a photochromic agent has been incorporated. Following this order, for conducting grafting and impregnation steps, is relatively unusual, given the state of the art.

In a fourth alternative method, the post-synthetic grafting additional step is conducted before the step of removing the pore-forming agent.

Hydrophobic reactive compounds bearing at least one hydrophobic group which are particularly suitable in the present invention are compounds based on a tetravalent metal or metalloid, preferably on silicon, comprising only one function which is able to react with the film residual hydroxyl groups, in particular a Si—Cl, Si—NH—, or Si—OR function, where R is an alkyl group, preferably a C₁-C₄ alkyl group.

Preferably, said hydrophobic reactive compound is selected from compounds and mixtures of compounds of formula (IX):

(R¹)₃(R²)M (IX)

wherein:
M is a tetravalent metal or metalloid, for example Si, Sn, Zr, Hf or Ti, preferably silicon.
the R¹ groups, being the same or different, represent saturated or unsaturated, preferably C₁-C₈ and more preferably C₁-C₄, hydrocarbon hydrophobic groups, for example alkyl groups, such as methyl or ethyl groups, vinyl groups, aryl groups, for example phenyl groups, optionally substituted, in particular by one or more C₁-C₄ alkyl groups, or represent fluorinated or perfluorinated analogous groups of the previously mentioned hydrocarbon groups, for example fluoroalkyl or perfluoroalkyl groups, or (poly)fluoro or perfluoro alkoxy[(poly)alkylenoxy]alkyl groups. Preferably, R¹ is a methyl group.
R² represent a hydrolyzable group, preferably selected from an —O—R alkoxy group, in particular a C₁-C₄ alkoxy group, or an —O—C(O)R acyloxy group, where R is an alkyl radical, preferably a C₁-C₆ alkyl radical, preferably a methyl or ethyl radical, an amino group optionally substituted by one or two functional groups, for example by an alkyl or a silane group, and a halogen such as Cl, Br and I. Said group is preferably an alkoxy group, especially a methoxy or an ethoxy, a chloro or a —NHSiMe₃ group.

Hydrophobic reactive compounds to be advantageously used include fluoroalkyl chlorosilanes, especially a tri(fluoroalkyl)chlorosilane or a fluoroalkyl dialkyl chlorosilane such as 3,3,3-trifluoropropyldimethyl chlorosilane of formula CF₃—CH₂—CH₂—Si(CH₃)₂Cl, alkyl alkoxysilanes, especially a trialkyl alkoxysilane such as trimethyl methoxysilane (CH₃)₃SiOCH₃, fluoroalkyl alkoxysilanes, especially a tri(fluoroalkyl)alkoxysilane or a fluoroalkyl dialkyl alkoxysilane, alkyl chlorosilanes, especially a trialkyl chlorosilane such as trimethyl chlorosilane, trialkyl silazanes or hexaalkyl disilazanes. The hydrophobic reactive compound is necessarily different from the hydrophobic precursor agent used in the precursor sol.

In a preferred embodiment, the hydrophobic reactive compound comprises a trialkylsilyl group, preferably a trimethysilyl group, and a silazane group, in particular a disilazane group. Hexamethyl disilazane (CH₃)₃Si—NH—Si(CH₃)₃, noted HMDS, is a particularly preferred hydrophobic reactive compound.

In the first method of the invention, the final photochromic film may be ordered or not. As previously stated, an amphiphilic pore-forming agent is preferably used, which acts as a structuring agent, so that the final photochromic film does generally display an ordered structure. Generally speaking, a structured film has better mechanical properties, and the means for controlling the reproducibility of its production process are easier.

As used herein, “an ordered or organized structure” is intended to mean a structure having a periodic organization in a thickness of at least 20 nm, and in an area of at least 20 nm in size, preferably 300 nm, in the plane of the deposited layer.

Said ordered structure may especially be of the hexagonal 3d, cubic or hexagonal 2d type, at least locally. The hexagonal 3d structure is composed of spherical micelles arranged into a lattice similar to a compact hexagonal stack. Its space group is P6₃/mmc. The cubic structure (space group Pm3n) is composed of ellipsoidal and spherical micelles. The hexagonal 2d structure (space group c2m) is composed of cylinder-shaped micelles.

FIG. 1 appended to the present application shows part of the ternary diagram of the phases obtained in TEOS/MTEOS/CTAB films. It does illustrate the ordered structures (phases) which may be obtained in the final gel from a sol comprising these three components, depending on their mole ratio values.

When the MTEOS/TEOS mole ratio does reach a limit value higher than 1, the films may not be structured anymore. When the MTEOS/TEOS mole ratio is lower than this limit value, the mesoporous film of the invention may display an organized structure of the hexagonal 3d, cubic or hexagonal 2d type, depending on the CTAB amount used. The phase-delimiting CTAB/TEOS mole ratio values do increase as the MTEOS/TEOS mole ratio values do increase.

For example, when the pore-forming agent is CTAB, the inorganic precursor agent is TEOS and the hydrophobic precursor agent is MTEOS (introduced into the precursor sol prior to the deposition step b)), given a MTEOS/TEOS mole ratio=1, the result is:
a hexagonal 3d type ordered structure for 0.210≦(CTAB/TEOS)≦0.280;
a cubic type ordered structure for 0.297≦(CTAB/TEOS)≦0.332;
a hexagonal 2d-type ordered structure for 0.350≦(CTAB/TEOS)≦0.385.

Preferably, the amounts of both precursor agents and of the pore-forming agent are selected in step a) so that the mesoporous films obtained according to the first method of the invention at the end of step d) display a hexagonal 3d type ordered structure.

The second and third methods of the invention, which are methods said to be of “direct synthesis”, will now be described. They differ from the first method in that the photochromic agent is incorporated into the precursor sol, and not after the mesoporous film preparation.

The components which may be suitably used in both second and third methods are similar to those used in the first method and therefore will not be described again. Deposition and consolidation steps may as well be conducted in the same way. Only the differences between the respective methods will be mentioned hereafter.

The second method does generally imply the dissolution of at least one inorganic precursor agent, of at least one hydrophobic precursor agent, of at least one pore-forming agent and of at least one photochrome in a mixture of water and organic solvent to form a photochromic film precursor sol. This precursor sol is polymerized and generally forms a mesostructured photochromic film if the pore-forming agent is of the amphiphilic type, and a simply photochromic film if not. As for the first method, it is preferred to incorporate the precursor agents in two steps.

The third method of the invention does differ from the second in that the matrix is not made hydrophobic by incorporating into the precursor sol at least one hydrophobic precursor agent, but by means of a post-synthesis hydrophobation of the photochromic film, by treating said film with at least one hydrophobic reactive compound bearing at least one hydrophobic group such as previously described. This means that no hydrophobic precursor agent is incorporated into the precursor sol. This post-synthesis hydrophobation step is conducted subsequently to the deposition step b) or if present, subsequently to the consolidation step c). Conducting such a treatment on a film comprising in its structure a pore-forming agent and/or a photochromic agent was not known.

In the third method of the invention, the film matrix is composed of only one precursor agent type, i.e. the inorganic precursor agent.

In the context of the second method of the invention, post-treatment of the film may be conducted using at least one hydrophobic reactive compound bearing at least one hydrophobic group, such as previously described in the context of the first and third methods of the invention.

In the context of the second and third methods of the invention, the incorporation of the photochromic agent into the precursor sol may be performed by direct admixture, under stirring, of the photochromic agent or of a solution of the photochromic agent in an organic solvent or in a mixture of organic solvents. This enables to obtain a homogeneous solution of the photochromic agent in the precursor sol and as a consequence a homogeneous distribution of said agent within the final film. A small amount of additional organic solvent may be used, in order to help solubilizing the photochromic compound in the precursor sol. The solvents to be used especially include N,N-dimethyl formamide (DMF) and N-methylpyrrolidone (NMP). Incorporating the photochromic agent and incorporating the pore-forming agent into the precursor sol may be performed simultaneously. A photochromic compound stabilizing agent may also be incorporated into the precursor sol.

It is also possible to incorporate the photochromic agent into the precursor sol in the form of a dispersion of this photochrome in a solvent, provided that the precursor sol be ultimately homogeneous.

It should be noted that the photochromic agent and the pore-forming agent may be a unique compound, for example when the photochromic agent has in addition surface active properties.

Once the precursor sol of the photochromic film has been prepared, it is recommended to rapidly perform its deposition onto a main surface of the substrate. Indeed, the stability of a mixture composed of a photochromic agent and of a sol is very poor, the photochromic agents used being sensitive to the acidic pH of the sol. Neutralizing the sol can not be considered because it would lead to the polymerization of the silica, and the film synthesis would not be reproducible. The substrate coated with an optionally mesostructured, photochromic film, is recovered at the end of this step.

The photochromic compound is introduced into the precursor sol so as to obtain in the final film the expected photochromic effect. Generally, the photochromic agent introduced into the precursor sol represents from 0.05 to 10% by mass as related to the precursor sol total mass.

Any traditional photochromic agent may be used in the second and third methods of the invention, either alone or in admixture with other photochromic compounds. However, the photochromic agent should be sufficiently soluble in the precursor sol, which generally comprises a mixture of water and alkanol. Thus, the maximum amount of photochromic compound molecules which can be suitably incorporated into the film of the invention depends in this case on the solubility of these compounds in the precursor sol.

Generally, the pore-forming agent is not removed from the structure of the photochromic film in both second and third methods, what has no consequence on the final film properties, in particular when the pore-forming agent is a polymer, which remains located in the rigid matrix. However, both methods may include an additional step of selectively removing the pore-forming agent by any suitable method, for example by a solvent selective extraction, provided that the removal is conducted at a temperature lower than or equal to 150° C., preferably ≦130° C., more preferably ≦120° C. and even more preferably ≦110° C., and that it does not alter the photochrome. When the pore-forming agent is removed, a mesoporous photochromic film is obtained if the pore-forming agent is not of the amphiphilic type, and a generally structured mesoporous photochromic film if the pore-forming agent is of the amphiphilic type.

The additional step of selectively removing the pore-forming agent may be conducted before, during or after the optional (second method) or the required (third method) step of post-synthetic hydrophobation.

When the pore-forming agent is an amphiphilic molecule, the photochrome does insert within the hydrophobic part of the micelles, thus explaining its localization within the mesopores or micelles inner space in the final film.

In the final state, the photochromic films deposited according to the three methods of the invention generally have a maximum thickness of about 1 μm, and more generally a thickness ranging from 100 to 500 nm. Of course, several films may be successively deposited so as to obtain a multilayered film of the desired thickness and therefore having a sufficiently high absorbance. The thickness of this final multilayered film is determined by the magnitude of the expected photochromic effect and depends on the nature of the photochromic compound used.

The substrate onto which the films are deposited may be made of any solid, transparent or non transparent material, such as a mineral glass, a ceramics, a glass-ceramics, a metal or an organic glass, for example a thermoplastic or thermosetting plastic material. Preferably, the substrate is a mineral glass or an organic glass substrate, preferably transparent. More preferably, the substrate is a substrate made of a transparent plastic material.

Thermoplastic materials which may be suitably used for the substrates include (meth)acrylic (co)polymers, in particular polymethyl methacrylate (PMMA), thio(meth)acrylic (co)polymers, polyvinyl butyral (PVB), polycarbonates (PC), polyurethanes (PU), poly(thiourethanes), polyol allylcarbonate (co)polymers, ethylene and vinyl acetate thermoplastic copolymers, polyesters such as polyethylene terephthalate (PET) or polybutylene terephthalate (PBT), polyepisulfides, polyepoxides, polycarbonates and polyesters copolymers, cycloolefin copolymers such as ethylene and norbornene or ethylene and cyclopentadiene copolymers, and combinations thereof.

As used herein, a “(co)polymer” is intended to mean a copolymer or a polymer. As used herein, a “(meth)acrylate” is intended to mean an acrylate or a methacrylate.

The preferred substrates of the invention include substrates obtained by polymerizing alkyl(meth)acrylates, in particular C₁-C₄ alkyl(meth)acrylates, such as methyl(meth)acrylate and ethyl(meth)acrylate, polyethoxylated aromatic (meth)acrylates such as polyethoxylated bisphenol di(meth)acrylates, allyl derivatives such as linear or branched, aliphatic or aromatic polyol allylcarbonates, thio(meth)acrylates, episulfides, and polythiols and polyisocyanates precursor mixtures (to produce polythiourethanes).

Examples of polyol allylcarbonate (co)polymers include (co)polymers of ethylene glycol bis(allylcarbonate), diethylene glycol bis(2-methyl allylcarbonate), diethylene glycol bis(allylcarbonate), ethylene glycol bis(2-chloro allylcarbonate), triethylene glycol bis(allylcarbonate), 1,3-propane diol bis(allylcarbonate), propylene glycol bis(2-ethyl allylcarbonate), 1,3-butene diol bis(allylcarbonate), 1,4-butene diol bis(2-bromo allylcarbonate), dipropylene glycol bis(allylcarbonate), trimethylene glycol bis(2-ethyl allylcarbonate), pentamethylene glycol bis(allylcarbonate), isopropylene bisphenol A bis(allylcarbonate).

Particularly recommended substrates are substrates obtained by (co)polymerizing the diethylene glycol bis(allylcarbonate), sold, for example, under the trade name CR 39® by the PPG Industries company (ORMA® lenses from ESSILOR).

Particularly recommended substrates further include substrates obtained by polymerizing thio(meth)acrylic monomers, such as those described in the French patent application FR 2734827, and polycarbonates.

Of course, the substrates may be obtained by polymerizing mixtures of the hereabove mentioned monomers, or they even may comprise mixtures of these polymers and (co)polymers.

Given that all the steps of the methods of the invention are performed at low temperatures, they are compatible with these ophthalmic organic substrates.

The photochromic films of the invention may be formed onto a main surface of a bare substrate, that is to say an uncoated substrate, or onto a main surface of an already coated substrate having one more functional coatings.

Preferably, the substrate of the invention is a substrate for an ophthalmic lens. In ophthalmic optics, it is well known to coat a main surface of a substrate made of a transparent organic material, for example an ophthalmic lens, with one or more functional coatings to improve the optical and/or mechanical properties of the final lens. Therefore, the substrate main surface may be beforehand provided with a primer coating improving the impact resistance (impact-resistant primer coating) and/or the adhesion of the subsequent layers in the final product, with an abrasion-resistant and/or scratch-resistant coating (hard coat), with an antireflective coating, with a polarizing coating, with another photochromic coating, with a coloured coating or with a stack composed of at least two of such coatings.

Primer coatings improving the impact resistance are preferably polyurethane latices or acrylic latices.

Abrasion-resistant and/or scratch-resistant coatings are preferably hard coatings based on poly(meth)acrylates or silicones. Recommended abrasion-resistant and/or scratch-resistant hard coatings in the present invention include coatings obtained from silane hydrolyzates-based compositions, in particular epoxysilane hydrolyzates-based compositions, such as those described in the French patent application FR 2702486 and in the U.S. Pat. No. 4,211,823 and U.S. Pat. No. 5,015,523.

A preferred composition for abrasion-resistant and/or scratch-resistant coatings is the one disclosed in the patent FR 2702486, which comprises an epoxy trialkoxysilane and dialkyl dialkoxysilane hydrolyzate, colloidal silica and, in a catalytic amount, an aluminum-based curing catalyst such as aluminum acetylacetonate, the rest being substantially composed of solvents traditionally used for formulating such compositions. The hydrolyzate used is preferably a γ-glycidoxypropyl trimethoxysilane (GLYMO) and dimethyl diethoxysilane (DMDES) hydrolyzate.

The mesoporous film according to the invention is preferably coated itself with a hydrophobic and/or oleophobic layer (top coat) whose thickness is generally lower than 10 nm. These hydrophobic and/or oleophobic coatings are well known in the art and are generally obtained using thermal evaporation traditional methods. Said coatings are generally produced from fluorosilicones or fluorosilazanes, that is to say fluorine atom-containing silicones or silazanes.

Fluorosilanes which are particularly well adapted to form hydrophobic and/or oleophobic coatings are those having fluoropolyether moieties described in the U.S. Pat. No. 6,277,485.

These fluorosilanes have the following general formula:

R_{F}R¹—SiY₃₋ₓR²ₓ_{y}

wherein R_{F} is a monovalent or divalent polyfluoropolyether group, R¹ is an alkylene or arylene divalent group or a combination thereof, optionally comprising one or more heteroatoms or functional groups, and optionally substituted by halogens, and having preferably from 2 to 16 carbon atoms; R² is a lower alkyl group (that is to say a C₁-C₄ alkyl group); Y is a halogen atom, a lower alkoxy group (that is to say a C₁-C₄ alkoxy group, preferably a methoxy or ethoxy group), or a lower acyloxy group (that is to say —OC(O)R³ where R³ is a C₁-C₄ alkyl group); x is 0 or 1; and y is 1 (R_{F} is a monovalent radical) or 2 (R_{F} is a divalent radical). Suitable compounds generally have a number average molecular mass of at least 1000. Preferably, Y is a lower alkoxy group and R_{F} is a perfluoropolyether group.

Other recommended fluorosilanes are those having the following formulae:

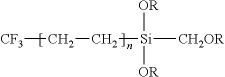

where n=5, 7, 9 or 11 and R is an alkyl group, preferably a C₁-C₁₀ alkyl group such as —CH₃, —C₂H₅ and —C₃H₇;
CF₃CH₂CH₂SiCl₃;

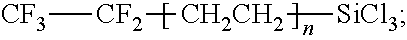

el and

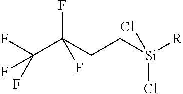

where n=7 or 9 and R is such as hereabove defined.

Fluorosilane-containing compositions which are also recommended for making hydrophobic and/or oleophobic coatings are described in the U.S. Pat. No. 6,183,872. They comprise fluoropolymers with organic moieties bearing silicon-based groups illustrated by the following general formula and having a molecular mass of from 5.10² to 1.10⁵:

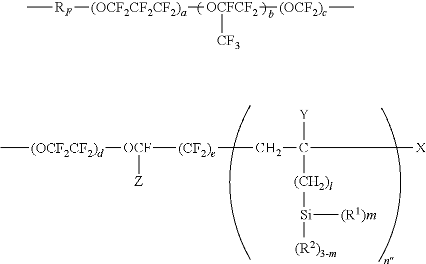

wherein R_{F} represents a perfluoroalkyl moiety; Z represents a fluoro or trifluoromethyl group; a, b, c, d and e each represent, independently from one another, 0 or an integer higher or equal to 1, provided that the sum of a+b+c+d+e is not lower than 1 and that the order of the recurrent units given between the brackets indexed under a, b, c, d and e are not limited to that represented; Y represents H or an alkyl group comprising from 1 to 4 carbon atoms; X represents a hydrogen, bromine or iodine atom; R¹ represents a hydroxyl group or a hydrolyzable group; R² represents a hydrogen atom or a monovalent hydrocarbon group; l represents 0, 1 or 2; m represents 1, 2 or 3; and n″ represents an integer at least equal to 1, preferably at least equal to 2.

A preferred hydrophobic and/or oleophobic coating composition is marketed by the Shin-Etsu Chemical company under the trade name KP 801M®. Another preferred hydrophobic and/or oleophobic coating composition is marketed by the Daikin Industries company under the trade name OPTOOL DSX®. It is a fluorinated resin comprising perfluoropropylene groups.

The photochromic films of the invention have applications in very diversified fields: optical lenses, in particular ophthalmic lenses, especially spectacle glasses, data optical storage, guided optics (optical waveguides), diffraction networks, Bragg mirrors, insulants for microelectronics, filtration membranes and chromatography stationary phases, this list being of course non limitative.

The substrate onto which the photochromic film of the invention is formed may also be a temporary substrate, onto which said film is stored, waiting for a transfer onto a definitive substrate such as a substrate for an ophthalmic lens.

Said temporary substrate may be rigid or flexible, preferably flexible. It is a removable substrate, i.e. intended to be removed once the transfer of the photochromic film onto the definitive substrate has been carried out.

The temporary substrate may be used having been beforehand coated with a layer of a mold release agent intended to facilitate the transfer. This layer may optionally be removed at the end of the transfer step.

Flexible temporary substrates generally are fine elements of a few millimeters thick, preferably between 0.2 and 5 mm thick, more preferably between 0.5 and 2 mm thick, made of a plastic material, preferably a thermoplastic material.

Examples of thermoplastic (co)polymers to be suitably used for making a temporary substrate are polysulfones, aliphatic poly(meth)acrylates, such as methyl poly(meth)acrylate, polyethylene, polypropylene, polystyrene, SBM (styrene-butadiene-methyl methacrylate) block copolymers, polyphenylene sulfide (PPS), arylene polyoxides, polyimides, polyesters, polycarbonates such as bisphenol A polycarbonate, polyvinyl chloride, polyamides such as nylons, as well as copolymers and mixtures thereof. Polycarbonate is the preferred thermoplastic material.

The temporary substrate main surface may comprise a stack composed of one or more functional coatings (already described) which will be transferred together with the photochromic film of the invention onto the definitive substrate. Of course, the coatings to be transferred have been deposited onto the temporary substrate in reverse order as related to the desired stacking order on the definitive substrate.

When the substrate onto which the film of the precursor sol is deposited during step b) of the methods of the present invention is a temporary substrate, the invention further relates to a method for transferring the photochromic film (or a stack of coatings comprising said photochromic film) from the temporary substrate onto a definitive substrate. Methods of the invention then comprise the following additional step:
z) transferring said photochromic film from the temporary substrate onto a definitive substrate.

Transferring of the coating(s) present on the temporary substrate may be performed according to any suitable method known from the man skilled in the art.

It is another object of the invention to provide an article comprising a substrate having a main surface coated with a photochromic film, where said article is obtained or might be obtained by any of the previously described methods. Said photochromic film has preferably a hexagonal 3d type ordered structure and said substrate is preferably made of an organic material. Said article is preferably an ophthalmic lens.

As previously explained, the substrate may be transparent and may comprise one or more functional coatings, and the photochromic film may be deposited onto any of them. The substrate may be a temporary substrate or a definitive substrate such as an optical substrate.

According to one embodiment of the invention, the photochromic film is formed onto an abrasion-resistant and/or scratch-resistant coating.

Preferably, the photochromic film is the penultimate layer in the stacking order, being coated itself with a hydrophobic and/or oleophobic layer. The “ultimate layer of the stack” in the present application will be considered as the layer being the most distant from the substrate.

The following examples do illustrate the present invention without limitation. Unless otherwise specified, all percentages herein are expressed in mass %.

### EXAMPLES

### Reactants Used for the Synthesis of the Photochromic Films

TEOS of formula Si(OC₂H₅)₄ has been used as an inorganic precursor agent of formula (I), MTEOS of formula CH₃Si(OC₂H₅)₃ has been used as a hydrophobic precursor agent. Three pore-forming agents of the surfactant type have been tested: CTAB of formula C₁₆H₃₃N(CH₃)₃Br, PE6800 noted (EO)₇₃-(PO)₂₈-(EO)₇₃, and PE10400 noted (EO)₂₇—(PO)₆₁-(EO)₂₇. The hydrophobic reactive compound used in some examples is hexamethyl disilazane (HMDS). The tested photochrome is the preferred photochrome of the invention, 5-methoxy-3,3-dimethyl-1-propylspiro[indoline-2,3′-[3H]pyrido[3,2-f]-[1,4]benzoxazine], of formula (IV) shown hereunder again. Such a spirooxazine has been selected because it is a very “slow” molecule (low colouring and bleaching kinetic constants), very sensitive to its environment, which has made it possible to determine which are the most adapted matrices to a correct photochrome functioning. Sols have been prepared using absolute ethanol as an organic solvent and dilute hydrochloric acid (so as to obtain a pH value of 1.25) as a hydrolysis catalyst.

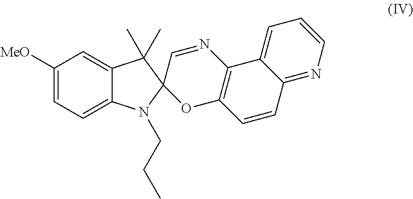 [SMILES: CCCN1c2ccc(OC)cc2C(C)(C)C12C=Nc1c(ccc3ncccc13)O2]

### A) First Method of the Invention (Impregnation)

The preparation of the precursor sol of a mesoporous film according to the first method of the invention is a method of incorporating the precursor agents in two steps. During the first step, a silica sol comprising the inorganic precursor agent is prepared. The hydrophobic precursor agent is incorporated into this sol during a second step.

### 1. General Procedure for Preparing the Silica Sol

The mole ratios of the silica sol components are as follows: TEOS/ethanol/HCl—H₂O=1:3.8:5. TEOS is hydrolyzed and then partially condensed by heating for 1 h at 60° C. in a medium composed of ethanol and dilute hydrochloric acid, in a flask provided with a refrigerant.

The prepared silica sol is composed of polymer small aggregates of partially condensed silica, comprising a large amount of silanol functions, which do disappear in part if a hydrophobic precursor agent such as MTEOS is introduced into the sol. This synthesis was thus conceived so that the whole {silica polymer aggregates+MTEOS} remains sufficiently hydrophilic so as not to alter the system hydrophilic-hydrophobic balance. Indeed, polymerized MTEOS is hydrophobic, as opposed to hydrolyzed and non condensed MTEOS. The synthesis was also conceived so as to preserve the reactivity of the silica aggregates (more precisely, their gelling rate), which is generally altered by the presence of MTEOS.

### 2. General Procedure for Depositing a MTEOS-TEOS Matrix-Based Mesostructured Film of the Invention (MTEOS/TEOS Mole Ratio=40:60)

A pore-forming agent stock solution comprising 48.7 g of CTAB per liter of ethanol is prepared. Dissolution may be facilitated using ultrasounds for a couple of seconds. 6.7 mL thereof are collected, and then 0.75 mL of pure MTEOS are added thereto. 3 mL of the silica sol hereabove prepared are transferred into a flask dipped in an ice bath at 0° C. and enriched with 67 μl of acidified water (HCl pH=1.25). The whole is then added under stirring to the CTAB/ethanol/MTEOS mixture. 90 seconds later, a few drops of the thus prepared mixture are deposited on a 1.1 mm-thick glass substrate, which is then rotated at 3000 rpm for 2 minutes (acceleration of about 2000 rpm/s). The deposition is performed in a chamber flushed through with a strong nitrogen flow and whose atmosphere has a relative humidity RH equal to 51% at T=20-25° C. The obtained films, whose thickness measured by UV-visible ellipsometry is of about 260 nm, have a hexagonal 3d type ordered structure.

### 3. General Procedure for Depositing a Silica Matrix-Based Mesostructured Film

### Comparative Example

3 mL of the silica sol hereabove prepared are added to a volume of a surfactant stock solution (CTAB, PE6800 or PE10400) under stirring, so that the surfactant/Si mole ratio is such as defined in table 1. Then, a few drops of the thus prepared mixture are deposited onto a 1.1 mm-thick glass substrate, which is then rotated at 3000 rpm for 2 minutes (acceleration of about 2000 rpm/s).

The obtained structure is indicated in table 1 hereunder. When using CTAB, the deposition is performed in a chamber whose hygrometry is controlled by a bubbling nitrogen flow in a water tank. The atmosphere should be sufficiently humid (RH>60%, with a significant nitrogen flow rate), otherwise, the CTAB micelle arrangement to a periodic structure with large coherence domains does not correctly work.

The film obtained using CTAB as a pore-forming agent is around 340 nm thick.

TABLE 1

| | Surfactant/Si mole ratio | | |
|---|---|---|---|
| | CTAB/Si = 0.10 | PE6800/Si = 0.01 | PE10400/Si = 0.012 |
| Obtained | Hexagonal 3d | Face-centered | Centered |
| structure | (spherical micelles) | orthorhombic | rectangular |
| | | (ellipsoidal | (tubular micelles) |
| | | micelles) | |

### 4. General Procedure for Consolidating a Mesostructured Film and Removing the CTAB Surfactant

The substrate coated with the mesostructured film obtained in the hereabove paragraphs 2 (TEOS/MTEOS hydrophobic matrix) or 3 (TEOS silica matrix) is consolidated by heating to 110° C. for 12 hours, then CTAB is removed by an organic solvent extraction, as follows. The substrate coated with the consolidated film is dipped into reflux acetone (56° C.) for 2 hours. CTAB may also be solubilized by dipping the substrate coated with the consolidated film in reflux ethanol (78° C.) for 5 hours. The removal of CTAB may be followed by FTIR spectroscopy performed on the film after the substrate coated with the film has been removed from the mixture and has been rinsed a few minutes in acetone.

At the end of this step, a substrate coated with a mesoporous film is recovered (examples 2 and 3).

When a TEOS/MTEOS matrix and a silica matrix are used, it has been controlled by X-ray diffraction that the hexagonal 3d type ordered structure was kept after removal of CTAB. The periodic structure is preserved, with some deformation.

The obtained films are highly porous (void fraction of about 55%). They comprise both well calibrated mesopores of 4 nm diameter (micellar imprinting), and micropores of a few angstroms diameter, located within the matrix walls, and a priori non monodispersed. As regards the porous morphology of the various films, mesopores generally represent ⅔ of the void volume and micropores generally represent ⅓ of the void volume, what could be determined by submitting the film to adsorption experiments.

FIG. 3 schematically represents the morphology of a silica matrix-based mesoporous film obtained after removal of the pore-forming agent. Two mesopores, separated from each other by microporous silica walls, are shown on the figure.

As a comparison, a MTEOS/TEOS matrix-based mesoporous film comprises approximately the same amounts of micropores and mesopores as the silica film illustrated on FIG. 3 does.

### 5. General Procedure for Treating a Mesoporous Film with a Hydrophobic Reactive Compound Bearing at Least One Hydrophobic Group (Alternative Method 2: Post-Synthetic Grafting Conducted Subsequently to the Pore-Forming Agent Removal Step but Before the Impregnation Step)

This treatment, intended to increase the hydrophobic character of the film, is perfromed herein in the vapor phase. The substrate coated with the mesoporous film obtained in paragraph 4 is introduced into a Schlenk tube with 200 μL of HMDS. The whole is placed under low static vacuum, and then heated to 70° C. for 5 minutes. The correct grafting of the trimethylsilyl groups may be monitored by FTIR spectroscopy performed on the film. The number of grafted methyl moieties is evaluated from the Si—CH₃ band area at 2965 cm⁻¹, as related to the thickness of the film. Such a procedure enables to prepare the examples 4 and 5 mesoporous films, which differ as regards their matrix type.

When a TEOS/MTEOS matrix and a silica matrix are used, it has been controlled that the hexagonal 3d type ordered structure was kept after the treatment with HDMS.

### 6. General Procedure for Impregnating a Mesoporous Film with a Photochrome

The substrate coated with the mesoporous film obtained in the hereabove paragraphs 4 or 5 (based on a silica matrix or on a MTEOS/TEOS matrix, optionally post-treated with HMDS) is impregnated by spin coating a solution at 5.10⁻³ mol/L of the photochrome of formula (IV) in cyclohexane (3000 rpm for 2 minutes). A substrate coated with a mesoporous photochromic film is recovered.

### 7. General Procedure for Treating a Mesoporous Photochromic Film with a Hydrophobic Reactive Compound Bearing at Least One Hydrophobic Group (Alternative Method 3: Post-Synthetic Grafting Conducted Subsequently to the Impregnation Step)

This treatment, intended to increase the hydrophobic character of the film, is performed herein in the vapor phase. The substrate coated with the mesoporous photochromic film having been previously submitted to the treatments described in paragraphs 2 (TEOS/MTEOS hydrophobic matrix) then 4, then 6, is introduced into a Schlenk tube with 200 μL of HMDS. The whole is placed under low static vacuum, and then heated to 70° C. for 5 minutes. Such a procedure enables to prepare the mesoporous photochromic film of example 6.

It has been controlled that the hexagonal 3d type ordered structure was kept after the treatment with HDMS.

### 8. Photochrome Behavior Study by UV-Visible Absorption Spectroscopy

The photochromic film is UV-irradiated, what induces a colouring of the film. The absorbance vs. time is monitored at the photochrome maximum absorbance wavelength in the visible. When the maximum absorbance is reached, the ultraviolet irradiation is stopped and the bleaching of the sample, expressed as a progressive return to a zero absorbance, is monitored in the dark. FIG. 2 is an example of a spectrum obtained during such a study conducted less than 24 hours after the photochromic film preparation.

The easiest available data, which significantly illustrates the photochrome behavior, is its kinetic constant of bleaching in the dark. It may be obtained by adjusting a monoexponantial model on the absorbance=f(time) bleaching curve. Using a biexponential model is sometimes necessary, what indicates that the photochrome is located in many different environments, for example, in the mesopores and in the walls separating the same from each other.

### 9. Results: Photochrome Colouring and Bleaching Kinetics Evaluation

In examples 2 to 6, the photochrome of formula (IV) has been incorporated into various mesoporous films by impregnation, such as described in the hereabove paragraph 6. The non mesoporous film of example 7 has been prepared by adding the photochrome to the sol prior to deposition.

Example 1 (comparative): the photochromic solution is deposited onto a dense surface (glass plate).
Example 2 (comparative): a silica matrix-based mesoporous film.
Example 3: a 40:60 MTEOS/TEOS matrix-based mesoporous film.
Example 4 (comparative): a mesoporous film based on a silica matrix made hydrophobic only by a post-synthetic treatment with HMDS.
Example 5: a mesoporous film based on a 40:60 MTEOS/TEOS matrix post-treated with HMDS before the impregnation.
Example 6: a mesoporous film based on a 40:60 MTEOS/TEOS matrix post-treated with HMDS after the impregnation.
Example 7 (comparative): dense (non mesoporous) and soft (poorly crosslinked, Tg<0° C.) sol-gel film, within which the photochrome is dispersed, such as described in FR 2795085 or in J. Mater. Chem. 1997, 7, 61-65.

Table 2 shows the results obtained at T=20° C., for λ_{excitation}=large 312 nm-centered spectrum. λₘₐₓ represents the position of the system maximum absorbance in its coloured form (in the visible). Aₘₐₓ is the corresponding absorbance.

TABLE 2

| | Photochrome kinetic | | | |
|---|---|---|---|---|
| | constant of bleaching | | | |
| Example | in the dark (s⁻¹) | λₘₐₓ (nm) | Aₘₐₓ | Aggregation |
| 1 (comparative) | 9.40 · 10⁻⁴ | 634 | 0.02 | Yes |
| 2 (comparative) | 8.20 · 10⁻⁵ | 594 | 0.06 | No |
| 3 (invention) | 1.12 · 10⁻³ | 608 | 0.15 | No |
| 4 (comparative) | 3.56 · 10⁻³ | 630 | 0.02 | Yes |
| 5 (invention) | 3.61 · 10⁻³ | 614 | 0.10 | No |
| 6 (invention) | 3.71 · 10⁻³ | 617 | 0.07 | No |
| 7 (comparative) | 1.40 · 10⁻³ | / | / | No |

Table 2 shows that the kinetic constants of bleaching in the dark are strongly correlated to the nature of the photochrome host.

In many examples, the photochrome molecules are aggregated and not active anymore, what is expressed by a low absorbance (0.02). That is the case in example 1 (no matrix) and in example 4. Without wishing to be limited by any particular theory, the present inventors think that this is due to steric reasons, what will be explained hereafter. A high value of λₘₐₓ (630 or 634 nm) is another indication of aggregation. Such a value has been reached when the photochrome has been deposited onto dense surfaces of various natures (hydrophilic or hydrophobic surfaces). Thus, both parameters λₘₐₓ and Aₘₐₓ allow to identify the situations where the photochrome in not able to correctly diffuse within a porous structure.

Comparing the results of examples 2 and 3 does reveal the superiority of a hydrophobic matrix (MTEOS/TEOS) over a silica matrix, as regards the correct functioning of the photochrome, its correct diffusion within the mesopores during the impregnation step and its correct dispersion within the matrix. The best value of Aₘₐₓ in example 3 a priori indicates that a higher amount of photochromic agent has been incorporated into the film. In addition, only the MTEOS/TEOS matrix enables to obtain fast colouring and bleaching kinetics.

The post-treatment of a mesoporous film with HMDS, prior to being impregnated with the photochrome, does improve the colouring and bleaching kinetics, whether the initial matrix is hydrophobic or not, but limits the diffusion of the photochrome within the mesopores. This can be explained very easily, as a non post-grafted mesoporous film is much more porous than the same film which would be postgrafted. A satisfying value of Aₘₐₓ is however obtained with the postgrafted MTEOS/TEOS matrix-based film of example 5 of the invention.

On the contrary, the post-treatment of the silica matrix-based film with HMDS, which enables to obtain a hydrophobic matrix, causes the photochrome to aggregate on the surface of the film, and as a consequence thereof the absorbance is low. It should be noted that the post-treatment of a silica matrix-based mesoporous film with HMDS does remove ¾ of the micropores which are present within the walls. The walls are thus densified, what limits the photochrome diffusion and prevents it from entering the film. Without wishing to be limited by any particular theory, the present inventors think that there is no aggregation to observe when the photochrome is incorporated into a film based on a MTEOS/TEOS hydrophobic matrix which has been post-treated with HMDS, because the MTEOS/TEOS hydrophobic matrix-based films comprise less silanol SiOH groups which might be grafted with HMDS. The porosity decrease resulting from this grafting is therefore less significant.

It should be noted that the colouring and bleaching kinetics are comparable, whether the post-treatment with HMDS is performed before or after the impregnation of the film with the photochrome, when using a MTEOS/TEOS hydrophobic matrix-based film.

To conclude, it is preferred from the photochromic properties point of view to work with a hydrophobic matrix obtained by incorporating into the silica sol a suitable amount of a hydrophobic precursor agent, rather than to work with a silica matrix which would have been made hydrophobic only by post-synthetic grafting.

### B) Second and Third Methods of the Invention (Direct Synthesis)

### 1. General Procedure for Preparing a MTEOS-TEOS Matrix-Based Mesostructured Photochromic Film (MTEOS/TEOS Mole Ratio=40:60, CTAB/TEOS Mole Ratio=0.16 and Photochrome/TEOS Mole Ratio=0.01), According to the Second Method of the Invention

A pore-forming agent stock solution comprising 48.7 g of CTAB per liter of ethanol is prepared. Dissolution may be facilitated using ultrasounds for a couple of seconds. 6.7 mL of this stock solution are collected, and added to 21.7 mg of the photochrome of formula (IV), then 0.75 mL of pure MTEOS are added to this mixture.

3 mL of a silica sol similar to that of the hereabove paragraph A)₁. (TEOS/ethanol/HCl—H₂O=1:3.8:5) are cooled in a flask dipped in an ice bath at 0° C., enriched with 67 μl of acidified water (HCl pH=1.25), then transferred under stirring into the mixture composed of photochrome, CTAB, ethanol and MTEOS.

90 seconds later, a few drops of the thus prepared mixture are deposited onto a 1.1 mm-thick glass substrate, which is then rotated at 3000 rpm for 2 minutes (acceleration of about 2000 rpm/s). The deposition is performed in a chamber flushed through with a strong nitrogen flow and whose atmosphere has a relative humidity RH equal to 51% at T=20-25° C. The obtained films have a hexagonal 3d type ordered structure.

Such a procedure enables to prepare the photochromic film of example 11.

### 2. General Procedure for Preparing a Silica Matrix-Based Mesostructured Photochromic Films (Photochrome/TEOS Mole Ratio=0.01)

Three solutions of pore-forming agents and photochrome in ethanol are prepared, comprising respectively 343 mg of CTAB and 36.2 mg of the photochrome of formula (IV) in 7 mL of ethanol, 376 mg of PE6800 and 18.1 mg of the photochrome of formula (IV) in 3.5 mL of ethanol, and 402 mg of PE10400 and 21.7 mg of the photochrome of formula (IV) in 3 mL of ethanol.

Three silica sols similar to that of the hereabove paragraph A)₁. (TEOS/ethanol/HCl—H₂O=1:3.8:5), with respective volumes of 5 mL, 2.5 mL and 3 mL, are cooled to 20° C., respectively enriched with 112 μL, 56 μL and 67 μL of acidified water (HCl pH=1.25) then respectively transferred into the hereabove prepared three solutions of pore-forming agents and photochrome.

Immediately after, a few drops of the thus prepared mixture are deposited onto 1.1 mm-thick glass substrates, which are then rotated at 3000 rpm for 2 minutes (acceleration of about 2000 rpm/s). The deposition is performed in a chamber flushed through with a strong nitrogen flow and whose atmosphere has a relative humidity RH equal to 51% at T=20-25° C. The obtained films are all structured (X-ray diffraction control).

Such a procedure enables to respectively prepare the photochromic films of the comparative examples 8, 9 and 10.

3. General Procedure for Preparing Mesostructured Photochromic Film Based on a Silica Matrix Made Hydrophobic by a Post-Synthetic Treatment with HMDS, According to the Third Method of the Invention (Photochrome/TEOS Mole Ratio=0.01)

A silica matrix-based film, mesostructured with CTAB, similar to that of the hereabove example 8, is treated with HMDS in the vapor phase at 70° C. under low static vacuum, such as described in the hereabove paragraph A) 5., but overnight, rather than for 5 minutes. This treatment time difference is due to the fact that the treated film this time has incorporated into its structure both a photochrome and a pore-forming agent.

Such a procedure enables to prepare the photochromic film of example 12.

### 4. Results: Photochrome Colouring and Bleaching Kinetics Evaluation

In examples 8 to 12, the photochrome of formula (IV) was incorporated into various films by direct synthesis, such as described in the hereabove paragraphs 1 to 3. The non mesoporous film of example 7 was prepared by adding the photochrome to the sol prior to deposition.

Example 7 (comparative): a dense (non mesoporous) and soft (poorly crosslinked, Tg<0° C.) sol-gel film, within which the photochrome is dispersed, such as described in FR 2795085 or in J. Mater. Chem. 1997, 7, 61-65 (similar to comparative example 7 of §A).
Example 8 (comparative): a silica matrix-based, CTAB-mesostructured film.
Example 9 (comparative): a silica matrix-based, PE6800-mesostructured film.
Example 10 (comparative): a silica matrix-based, PE10400-mesostructured film.
Example 11 (second method of the invention): a 40:60 MTEOS/TEOS matrix-based, CTAB-mesostructured film.
Example 12 (third method of the invention): a CTAB-mesostructured film based on a silica matrix post-treated with HMDS.
The determination of the photochrome kinetic constant of bleaching in the dark has been conducted such as described in the hereabove paragraph A) 8., by adjusting a monoexponantial model on the absorbance=f(time) bleaching curve. Using a biexponential model was sometimes necessary, what indicates that the photochrome is located in many different environments, for example, in the mesopores and in the walls separating the same from each other.

Table 3 shows the results obtained at T=20° C., for λ_{excitation}=large 312 nm-centered spectrum.

TABLE 3

| | Photochrome kinetic constant of |
|---|---|
| Example | bleaching in the dark (s⁻¹) |
| 7 (comparative) | 1.40 · 10⁻³ |
| 8 (comparative) | 3.69 · 10⁻⁴ and 6.98 · 10⁻⁵ (*) |
| 9 (comparative) | 1.81 · 10⁻³ |
| 10 (comparative) | 2.37 · 10⁻³ |
| 11 (invention) | 2.73 · 10⁻⁴ and 1.81 · 10⁻⁵ (*) |
| 12 (invention) | 1.13 · 10^{-3 and} 2.10 · 10⁻⁴ (*) |

(*) Biexponential model.

The results show that a mesostructured film based on a silica matrix made hydrophobic by a post-treatment with a hydrophobic compound (example 12) is of higher quality as compared to the same film which has not undergone such a hydrophobation treatment (example 8), as regards the photochrome correct functioning: surprisingly, the bleaching rate is three times higher in the film prepared according to the third method of the invention.

The MTEOS/TEOS hydrophobic matrix-based photochromic film (example 11) and the MTEOS silica matrix-based film (example 8) display comparable kinetic performances. However, the hydrophobic matrix-based photochromic film of the invention is advantageously insensitive to a humid atmosphere, resulting in an improved stability of its properties over time.

1-44. (canceled)

45. A method for making a substrate coated with a photochromic film, comprising:
a) preparing a precursor sol of a photochromic film comprising:
an inorganic precursor agent selected from compounds of formula:
M(X)₄ (I)
wherein the X groups, independently, are hydrolyzable groups and M is a tetravalent metal or metalloid;
at least one organic solvent;
at least one pore-forming agent; and
water;
b) depositing a film of the precursor sol onto a main surface of a substrate and forming a film; and
c) recovering a substrate coated with a photochromic film;
wherein the method further comprises:
i) introducing at least one hydrophobic precursor agent bearing at least one hydrophobic group into the precursor sol prior to step b) of depositing the precursor sol film; or
treating the film subsequently to step b) with at least one hydrophobic reactive compound bearing at least one hydrophobic group,
wherein the precursor sol further comprises a photochromic compound and at least one hydrophobic precursor agent bearing at least one hydrophobic group, and depositing the film of the precursor sol onto the main surface of a substrate forms a photochromic film; or
ii) introducing at least one hydrophobic precursor agent bearing at least one hydrophobic group into the precursor sol prior to step b) of depositing the precursor sol film, and
removing the pore-forming agent from the film resulting from step b) at a temperature ≦150° C. to form a mesoporous film and impregnating the mesoporous film with a solution comprising at least one photochromic agent to form a mesoporous photochromic film.

46. The method of claim 45, wherein the pore-forming agent represents from 2 to 10% as related to the precursor sol total mass.

47. The method of claim 45, wherein all the steps are conducted at a temperature ≦150° C.

48. The method of claim 45, wherein the hydrolyzable X groups of the compound of formula (I) are C₁-C₄ alkoxy groups, —O—C(O)R acyloxy groups in which R is a C₁-C₆ alkyl radical, halogens, and combinations thereof.

49. The method of claim 45, wherein the tetravalent metal or metalloid M of the compound of formula (I) is Ti, Zr, Hf, Sn or Si.

50. The method of claim 45, wherein the pore-forming agent is a non-ionic, cationic, anionic or amphoteric surfactant.

51. The method of claim 45, wherein the pore-forming agent is selected from cetyl trimethyl ammonium bromide, cetyl trimethyl ammonium chloride, ethylene oxide and propylene oxide three-block copolymer, ethylene oxide and propylene oxide two-block copolymer, or poly(ethylenoxy)alkyl-ether.

52. The method of claim 45, wherein the photochromic agent is a hydrophobic organic compound further defined as comprising at least one oxazine derivative, chromene, chromene-derived photochromic compound, fulgide, fulgimide, or dithizonate organometallic derivative.

53. The method of claim 52, wherein the photochromic agent is a benzoxazine or a naphthoxazine.

54. The method of claim 45, wherein the substrate is a substrate for an ophthalmic lens.

55. The method of claim 45, wherein the substrate of step b) is a temporary substrate and the method comprises transferring the photochromic film from the temporary substrate onto a definitive substrate.

56. The method of claim 45, further comprising treating the film subsequently to step b) and any consolidation step of the film deposited in step b) with at least one hydrophobic reactive compound bearing at least one hydrophobic group, the hydrophobic reactive compound being different from the hydrophobic precursor agent if such an agent is present in the precursor sol.

57. The method of claim 56, wherein the hydrophobic reactive compound comprises a compound of formula (IX):
(R¹)₃(R²)M (IX)
wherein:
M is a tetravalent metal or metalloid;
the R¹ groups, independently, are saturated or unsaturated hydrocarbon hydrophobic groups; and
R² is a hydrolyzable group.

58. The method of claim 57, wherein the hydrophobic reactive compound is a trialkylchlorosilane, a trialkylalkoxysilane, a fluoroalkyl alkoxysilane, a fluoroalkyl chlorosilane, a trialkylsilazane, or a hexaalkyldisilazane.

59. The method of claim 45, further comprising introducing at least one hydrophobic precursor agent bearing at least one hydrophobic group into the precursor sol wherein the hydrophobic precursor agent comprises a compound of formula (II) or (III):
(R¹)ₙ₁(R²)ₙ₂M (II)
or
(R³)ₙ₃(R⁴)ₙ₄M-R′-M(R⁵)ₙ₅(R⁶)ₙ₆ (III)
wherein:
M is a tetravalent metal or metalloid;
R¹, R³ and R⁵, independently, are saturated or unsaturated and substituted or unsubstituted hydrocarbon hydrophobic groups;
R², R⁴ and R⁶, independently, are hydrolyzable groups;
R′ is a divalent group;
n₁ is an integer ranging from 1 to 3, n₂ is an integer ranging from 1 to 3, n₁+n₂=4; and
n₃, n₄, n₅, and n₆ are integers ranging from 0 to 3, provided that the sums of n₃+n₅ and n₄⁺n₆ are different from zero, and n₃+n₄=n₅+n₆=3.

60. The method of claim 45, further comprising introducing at least one hydrophobic precursor agent bearing at least one hydrophobic group into the precursor sol, wherein the mole ratio of the hydrophobic precursor agent to the inorganic precursor agent varies from 10:90 to 50:50.

61. The method of claim 45, further comprising introducing at least one hydrophobic precursor agent bearing at least one hydrophobic group into the precursor sol, wherein the weight ratio of the pore-forming agents to both the precursor agents of formula (I) and the hydrophobic precursor agents added to the precursor sol is from 0.01 to 5.

62. The method of claim 45, further comprising introducing at least one hydrophobic precursor agent bearing at least one hydrophobic group into the precursor sol prior to step b) of depositing the precursor sol film; and removing the pore-forming agent from the film resulting from step b) at a temperature 150° C. to form a mesoporous film and impregnating the mesoporous film with a solution comprising at least one photochromic agent to form a mesoporous photochromic film, wherein removing the pore-forming agent is performed by a solvent or supercritical fluid extraction method, an ozone degradation method, a plasma treatment, a corona discharge treatment, or a photodegradation method by light irradiation exposure.

63. The method of claim 45, further comprising introducing at least one hydrophobic precursor agent bearing at least one hydrophobic group into the precursor sol prior to step b) of depositing the precursor sol film; and
removing the pore-forming agent from the film resulting from step b) at a temperature 150° C. to form a mesoporous film; and impregnating the mesoporous film with a solution comprising at least one photochromic agent to form a mesoporous photochromic film; and
treating the film with at least one hydrophobic reactive compound bearing at least one hydrophobic group different from the hydrophobic precursor agent during or subsequent to the step of removing the pore-forming agent.

64. The method of claim 63, further comprising treating the film with at least one hydrophobic reactive compound bearing at least one hydrophobic group different from the hydrophobic precursor agent subsequent to the step of impregnating the mesoporous film with a solution comprising at least one photochromic agent.

65. The method of claim 45, further comprising a step of treating the film subsequently to step b) with at least one hydrophobic reactive compound bearing at least one hydrophobic group; and further wherein:
the precursor sol further comprises a photochromic compound and depositing the film of the precursor sol onto the main surface of a substrate forms a photochromic film, and
there is no hydrophobic precursor agent incorporated into the precursor sol.

66. An article comprising a substrate having a main surface coated with a photochromic film, wherein said film is formed from a precursor sol comprising at least one organic solvent, at least one pore-forming agent, water, and an inorganic precursor agent selected from compounds of formula M(X)₄ (I), wherein the X groups, independently, are hydrolyzable groups and M is a tetravalent metal or metalloid, and wherein said photochromic film has been obtained by:
a) depositing a film of the precursor sol onto a main surface of a substrate and forming a film; and
b) recovering a substrate coated with a photochromic film;
wherein the method further comprises:
i) introducing at least one hydrophobic precursor agent bearing at least one hydrophobic group into the precursor sol prior to step a) of depositing the precursor sol film; or
treating the film subsequently to step a) with at least one hydrophobic reactive compound bearing at least one hydrophobic group,
wherein the precursor sol further comprises a photochromic compound and at least one hydrophobic precursor agent bearing at least one hydrophobic group, and depositing the film of the precursor sol onto the main surface of a substrate forms a photochromic film; or
ii) introducing at least one hydrophobic precursor agent bearing at least one hydrophobic group into the precursor sol, and
removing the pore-forming agent from the film resulting from step a) at a temperature ≦150° C. to form a mesoporous film and impregnating the mesoporous film with a solution comprising at least one photochromic agent to form a mesoporous photochromic film.

67. The article of claim 66, further defined as an ophthalmic lens.

68. The article of claim 66, wherein the photochromic film has a thickness ranging from 100 to 500 nm.
